(19) United States
(12) Patent Application Publication
(10) Pub. No.: US 2024/0152933 A1
(43) Pub. Date: May 9, 2024

(54) AUTOMATIC MAPPING OF A QUESTION OR COMPLIANCE CONTROLS ASSOCIATED WITH A COMPLIANCE STANDARD TO COMPLIANCE CONTROLS ASSOCIATED WITH ANOTHER COMPLIANCE STANDARD

(71) Applicant: Microsoft Technology Licensing, LLC, Redmond, WA (US)

(72) Inventors: Jong-Chin LIN, Bellevue, WA (US); Tianjing XU, Beijing (CN); Shashi KOSALRAM, Kirkland, WA (US); Ryan Wang GAO, Seattle, WA (US); Shanshan LIU, Beijing (CN); Lea VEGA ROMERO, Redmond, WA (US); Xinjian XUE, Carmel, IN (US); Qi LIU, Bellevue, WA (US); Sunitha Mary SAMUEL, Bellevue, WA (US); Alan Si-Rui LUK, Lynnwood, WA (US)

(21) Appl. No.: 17/982,315

(22) Filed: Nov. 7, 2022

(51) Int. Cl. G06Q 30/00; G06N 20/00

(52) U.S. Cl. CPC G06Q 30/018; G06N 20/00

(57) ABSTRACT

Techniques are described herein that are capable of automatic mapping of a question or compliance controls associated with a compliance standard to compliance controls associated with another compliance standard. Reference controls having respective first subsets of text-based features are identified. A question having a second subset of the text-based features or custom controls having respective second subsets of the text-based features are identified. Scores for the respective reference controls are determined for the question or each custom control using a supervised natural language processing machine learning model based at least on the first subsets of the text-based features and the second subset(s) of the text-based features. A compliance map is generated by automatically mapping the question or each custom control to a respective subset of the reference controls using the supervised natural language processing machine learning model based at least on the scores.

### BACKGROUND

Cloud customers frequently evaluate their solutions (e.g., end-to-end solutions) to determine whether the solutions are compliant with compliance standards associated with their industry. Examples of a compliance standard include but are not limited to a National Institute of Standards and Technology (NIST) standard developed and distributed by the NIST, an International Organization for Standardization (ISO) standard developed and distributed by the ISO, a Standard Occupational Classification (SOC) standard developed and distributed by the U.S. Bureau of Labor Statistics, a Payment Card Industry Data Security Standard (PCI DSS) developed and distributed by the Payment Card Industry Security Standards Council, and a Federal Risk and Authorization Management Program (FedRAIVIP) standard developed and distributed by executive branch entities of the United States government. Such compliance standards may pertain to security of data, backup and disaster recovery, hardware, privacy, geo-redundancy, and so on. Each customer typically develops its own custom compliance controls, which are intended to ensure that its solution complies with the relevant compliance standards, thereby enabling certification by an auditor.

A standard control framework typically defines implementation steps that are to be completed to achieve compliance and certification. Customers traditionally map their custom compliance controls to the standard control framework manually to determine which of their custom compliance controls have been correctly implemented as per industry standard audit requirements. Compliance managers often read through hundreds of control descriptions to manually determine which compliance controls of the standard control framework correspond to each custom compliance control. Making the determination manually often consumes substantial time and resources and may be error prone.

### SUMMARY

It may be desirable to automatically map a customer's custom compliance controls associated with a compliance standard or a customer's question associated with the compliance standard to reference compliance controls that are associated with another compliance standard for purposes of determining which of the reference compliance controls correspond to each custom compliance control or the question. For instance, by comparing features of the custom compliance controls or the question to features of the reference compliance controls, the reference compliance control(s) that correspond to each custom compliance control or the question may be determined. Automatically mapping the custom compliance controls or the question to the corresponding reference compliance controls in this manner may save a substantial amount of time and resources and may reduce a likelihood of error, as compared to manual mapping techniques. For instance, by automating the mapping, the amount of time and resources that are consumed to map the custom compliance controls or the question to the corresponding reference compliance controls may be reduced by 70-80%, as compared to the manual mapping techniques.

Various approaches are described herein for, among other things, automatically mapping a question or compliance controls associated with a compliance standard to compliance controls associated with another compliance standard. A compliance control that is associated with a compliance standard defines an action that, when performed, facilitates compliance of a cloud service with the compliance standard. Each compliance control has feature(s) that include information regarding the compliance control.

In a first example approach, reference controls of a reference control framework are identified. The reference controls define respective reference actions that, when performed, cause a cloud service to comply with a first compliance standard. Each reference control has a respective first subset of text-based features such that each text-based feature in the respective first subset includes information regarding the reference control. Custom controls of a custom control framework are identified. The custom controls define respective custom actions that, when performed, cause the cloud service to comply with a second compliance standard. Each custom control has a respective second subset of the text-based features such that each text-based feature in the respective second subset includes information regarding the custom control. For each custom control, scores for the respective reference controls are determined using a supervised natural language processing (NLP) machine learning (ML) model such that the scores are based at least on respective probabilities that the respective first subsets of the text-based features of the respective reference controls correspond to the second subset of the text-based features of the custom control. A compliance map is generated for the cloud service by automatically mapping each custom control of the custom control framework to a respective subset of the reference controls using the supervised NLP ML model based at least on each reference control in the respective subset of the reference controls having a score that satisfies a score criterion.

In a second example approach, reference controls of a reference control framework are identified. The reference controls define respective reference actions that, when performed, cause a cloud service to comply with a first compliance standard. Each reference control has a respective first subset of text-based features such that each text-based feature in the respective first subset includes information regarding the reference control. A question pertaining to compliance of the cloud service with a second compliance standard is received. The question has a second subset of the text-based features such that each text-based feature in the second subset includes information regarding the question. Scores for the respective reference controls are determined using a supervised natural language processing (NLP) machine learning (ML) model such that the scores are based at least on respective probabilities that the respective first subsets of the text-based features of the respective reference controls correspond to the second subset of the text-based features of the question. A compliance map is generated for the cloud service by automatically mapping the question to a subset of the reference controls using the supervised NLP ML model based at least on each reference control in the subset of the reference controls having a score in the plurality of scores that satisfies a score criterion.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example automatic compliance control mapping system in accordance with an embodiment.

FIGS. 2-5 depict flowcharts of example methods for automatically mapping compliance controls associated with a compliance standard to compliance controls associated with another compliance standard in accordance with embodiments.

FIGS. 6-9 depict flowcharts of example methods for automatically mapping a question associated with a compliance standard to compliance controls associated with another compliance standard in accordance with embodiments.

FIG. 10 is a block diagram of an example computing system in accordance with an embodiment.

FIG. 11 depicts an example compliance control in accordance with an embodiment.

FIG. 12 depicts an example user interface in accordance with an embodiment.

FIG. 13 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to automatically map a customer's custom compliance controls associated with a compliance standard or a customer's question associated with the compliance standard to reference compliance controls that are associated with another compliance standard for purposes of determining which of the reference compliance controls correspond to each custom compliance control or the question. For instance, by comparing features of the custom compliance controls or the question to features of the reference compliance controls, the reference compliance control(s) that correspond to each custom compliance control or the question may be determined.

Example embodiments described herein are capable of automatically mapping a question or compliance controls associated with a compliance standard to compliance controls associated with another compliance standard. A compliance control that is associated with a compliance standard defines an action that, when performed, facilitates compliance of a cloud service with the compliance standard. Each compliance control has feature(s) that include information regarding the compliance control.

Example techniques described herein have a variety of benefits as compared to conventional techniques for compliance control mapping. For instance, the example techniques are capable of automating mapping operations that traditionally have been performed manually. Accordingly, the amount of time that is consumed to perform the mapping operations may be reduced. A user experience of an information technology (IT) professional who is tasked with managing compliance of a cloud service with compliance standard(s) may be increased, for example, by obviating a need for the IT professional to perform mapping operations manually to determine which reference compliance controls associated with a reference compliance standard correspond to custom compliance controls or a question associated with another (e.g., new) compliance standard. By eliminating a need for the IT professional to perform the mapping operations manually, a cost of determining which reference compliance controls correspond to the custom compliance controls or the question may be reduced. For instance, time spent by an IT professional to perform manual mapping operations has an associated cost. By eliminating the manual mapping operations, the cost of determining which reference compliance controls correspond to the custom compliance controls or the question can be reduced by the labor cost associated with the IT professional performing the manual mapping operations.

The example techniques may be capable of considering dependencies between labels and/or features when mapping the custom compliance controls or the question to the corresponding reference compliance controls. For instance, each label may identify a question or a custom control and/or indicate a correlation (e.g., mapping) of a question or a custom control to a reference control. By taking into consideration such dependencies, accuracy, precision, and/or reliability of the mapping may be increased.

The example techniques may reduce an amount of time and/or resources (e.g., processor cycles, memory, network bandwidth) that is consumed to determine which reference compliance controls associated with a reference compliance standard correspond to custom compliance controls or a question associated with another compliance standard. For instance, by automatically mapping the custom compliance controls or the question to corresponding reference compliance controls, the time and/or resources that would have been consumed by an IT professional to perform the mapping manually is reduced (e.g., avoided). By reducing the amount of time and/or resources that is consumed by a computing system to map the custom compliance controls or the question to corresponding reference compliance controls, the efficiency of the computing system may be increased.

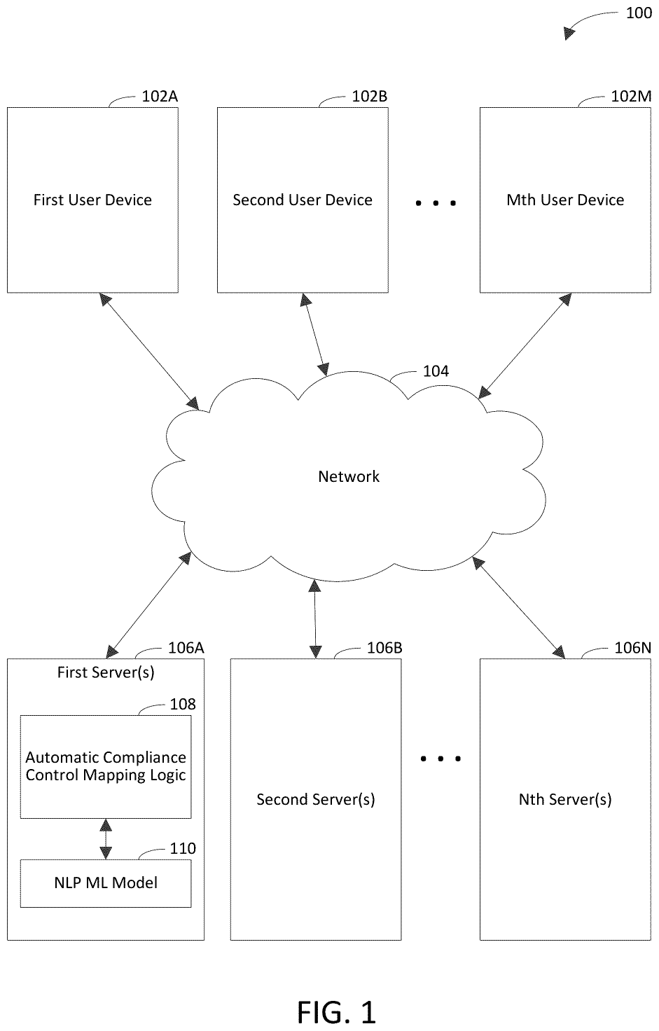

FIG. 1 is a block diagram of an example automatic compliance control mapping system 100 in accordance with an embodiment. Generally speaking, the automatic compliance control mapping system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the automatic compliance control mapping system 100 automatically maps a question associated with a compliance standard or custom compliance controls associated with the compliance standard to reference compliance controls that are associated with another compliance standard. Detail regarding techniques for automatically mapping a question or custom compliance controls associated with the compliance standard to reference compliance controls that are associated with another compliance standard is provided in the following discussion.

As shown in FIG. 1, the automatic compliance control mapping system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes a processing system comprising at least one processor that is capable of manipulating data in accordance with a set of instructions. For instance, a computing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the automatic compliance control mapping system 100.

One example type of computer program that may be executed by one or more of the servers 106A-106N is a cloud computing program (a.k.a. cloud service). A cloud computing program is a computer program that provides hosted service(s) via a network (e.g., network 104). For instance, the hosted service(s) may be hosted by any one or more of the servers 106A-106N. The cloud computing program may enable users (e.g., at any of the user systems 102A-102M) to access shared resources that are stored on or are otherwise accessible to the server(s) via the network.

The cloud computing program may provide hosted service(s) according to any of a variety of service models, including but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). For example, IaaS may provide to the user virtualized computing resources that utilize the IaaS provider's physical computer resources.

Examples of a cloud computing program include but are not limited to Google Cloud® developed and distributed by Google Inc., Oracle Cloud® developed and distributed by Oracle Corporation, Amazon Web Services® developed and distributed by Amazon.com, Inc., Salesforce® developed and distributed by Salesforce.com, Inc., AppSource® developed and distributed by Microsoft Corporation, Azure® developed and distributed by Microsoft Corporation, GoDaddy® developed and distributed by GoDaddy.com LLC, and Rackspace® developed and distributed by Rackspace US, Inc. It will be recognized that the example techniques described herein may be implemented using a cloud computing program. For instance, a software product (e.g., a subscription service, a non-subscription service, or a combination thereof) may include the cloud computing program, and the software product may be configured to perform the example techniques, though the scope of the example embodiments is not limited in this respect.

The first server(s) 106A are shown to include automatic compliance control mapping logic 108 and a natural language processing (NLP) machine learning (ML) model 110 for illustrative purposes. The NLP ML model 110 is a ML model that is capable of analyzing natural language data. For instance, the NLP ML model 110 may understand the natural language data and the contextual nuances of the language in the natural language data. By understanding the natural language data and the contextual nuances, the NLP ML model 110 may extract information and insights from the natural language data, categorize the natural language data, organize the natural language data, and so on. The NLP ML model 110 may be a supervised NLP ML model or an unsupervised NLP ML model. A supervised NLP ML model infers a function by analyzing labeled data (and potentially unlabeled data, as well). Labeled data is data that is associated (e.g., tagged) with one or more labels. A label that is associated with data includes information about the data. Unlabeled data is data that is associated with no labels. After the supervised NLP ML model infers the function, the supervised NLP ML model may use the function to predict a result based on previously unknown data. An unsupervised NLP ML model learns patterns from unlabeled data (and not labeled data).

The automatic compliance control mapping logic 108 is configured to use the NLP ML model 110 to automatically map a question associated with a compliance standard or custom compliance controls associated with the compliance standard to reference compliance controls that are associated with another compliance standard. In a first example implementation, the automatic compliance control mapping logic 108 identifies reference controls of a reference control framework. The reference controls define respective reference actions that, when performed, cause a cloud service to comply with a first compliance standard. Each reference control has a respective first subset of text-based features such that each text-based feature in the respective first subset includes information regarding the reference control. The automatic compliance control mapping logic 108 identifies custom controls of a custom control framework (e.g., in a compliance application). The custom controls define respective custom actions that, when performed, cause the cloud service to comply with a second compliance standard. Each custom control has a respective second subset of the text-based features such that each text-based feature in the respective second subset includes information regarding the custom control. For each custom control, the automatic compliance control mapping logic 108 determines scores for the respective reference controls using the NLP ML model 110 such that the scores are based at least on respective probabilities that the respective first subsets of the text-based features of the respective reference controls correspond to the second subset of the text-based features of the custom control. The automatic compliance control mapping logic 108 generates a compliance map for the cloud service by automatically mapping each custom control of the custom control framework to a respective subset of the reference controls using the NLP ML model 110 based at least on each reference control in the respective subset of the reference controls having a score that satisfies a score criterion.

In a second example implementation, the automatic compliance control mapping logic 108 identifies reference controls of a reference control framework. The reference controls define respective reference actions that, when performed, cause a cloud service to comply with a first compliance standard. Each reference control has a respective first subset of text-based features such that each text-based feature in the respective first subset includes information regarding the reference control. The automatic compliance control mapping logic 108 receives a question pertaining to compliance of the cloud service with a second compliance standard. The question has a second subset of the text-based features such that each text-based feature in the second subset includes information regarding the question. The automatic compliance control mapping logic 108 determines scores for the respective reference controls using the NLP ML model 110 such that the scores are based at least on respective probabilities that the respective first subsets of the text-based features of the respective reference controls correspond to the second subset of the text-based features of the question. The automatic compliance control mapping logic 108 generates a compliance map for the cloud service by automatically mapping the question to a subset of the reference controls using the NLP ML model 110 based at least on each reference control in the subset of the reference controls having a score in the plurality of scores that satisfies a score criterion.

The automatic compliance control mapping logic 108 may use the NLP ML model 110 to analyze (e.g., develop and/or refine an understanding of) features of the reference controls, relationships between the features of the reference controls, features of the custom controls, relationships between the features of the custom controls, features of the question, relationships between the features of the question, relationships between the features of the reference controls and the features of the custom controls, relationships between the features of the reference controls and the features of the question, and confidences in the aforementioned relationships. Accordingly, the NLP ML model 110 may learn probabilities of the respective reference controls to correspond to each custom control and/or to the question. The NLP ML model 110 may determine which of the reference controls to map to each custom control and/or to the question based on the probabilities. For instance, the NLP ML model 110 may map each custom control and/or the question to a subset of the reference controls based on the probability of each reference control in the subset satisfying a criterion (e.g., being greater than a threshold probability).

In some example embodiments, the automatic compliance control mapping logic 108 uses a neural network to perform the machine learning to determine (e.g., predict) the relationships between the features of the reference controls, the relationships between the features of the custom controls, the relationships between the features of the question, the relationships between the features of the reference controls and the features of the custom controls, the relationships between the features of the reference controls and the features of the question, and the confidences in the relationships. The automatic compliance control mapping logic 108 uses those relationships to determine (e.g., predict) which of the reference controls are to be mapped to each custom control and/or to the question.

Examples of a neural network include but are not limited to a feed forward neural network and a transformer-based neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the automatic compliance control mapping logic 108 employs a feed forward neural network to train the NLP ML model 110, which is used to determine ML-based confidences. Such ML-based confidences may be used to determine likelihoods that events will occur.

A transformer-based neural network is a neural network that incorporates a transformer. A transformer is a deep learning model that utilizes attention to differentially weight the significance of each portion of sequential input data. Attention is a technique that mimics cognitive attention. Cognitive attention is a behavioral and cognitive process of selectively concentrating on a discrete aspect of information while ignoring other perceivable aspects of the information. Accordingly, the transformer uses the attention to enhance some portions of the input data while diminishing other portions. The transformer determines which portions of the input data to enhance and which portions of the input data to diminish based on the context of each portion. For instance, the transformer may be trained to identify the context of each portion using any suitable technique, such as gradient descent.

In an example embodiment, the transformer-based neural network generates a mapping model (e.g., to indicate which reference controls are to be mapped to which custom controls and/or questions) by utilizing information, such as the features of the reference controls, relationships between the features of the reference controls, features of the custom controls, relationships between the features of the custom controls, features of the questions, relationships between the features of the questions, relationships between the features of the reference controls and the features of the custom controls, relationships between the features of the reference controls and the features of the questions, probabilities of the respective reference controls to correspond to each custom control and/or to each question, and ML-based confidences that are derived therefrom.

In example embodiments, the automatic compliance control mapping logic 108 includes training logic and inference logic. The training logic is configured to train a machine learning algorithm that the inference logic uses to determine (e.g., infer) the ML-based confidences. For instance, the training logic may provide sample features of sample reference controls and sample relationships therebetween, sample features of sample custom controls and sample relationships therebetween, sample features of sample questions and sample relationships therebetween, sample relationships between the sample features of the sample reference controls and the sample features of the sample custom controls, sample relationships between the sample features of the sample reference controls and the sample features of the sample questions, and sample probabilities of the respective sample reference controls to correspond to each sample custom control and/or to each sample question. The sample data may be labeled. The machine learning algorithm may be configured to derive relationships between the various features, the probabilities of the respective reference controls to correspond to each custom control and/or to each question, and the resulting ML-based confidences. The inference logic is configured to utilize the machine learning algorithm, which is trained by the training logic, to determine the ML-based confidence when the aforementioned features, probabilities, and ML-based confidences are provided as inputs to the algorithm.

The automatic compliance control mapping logic 108 may be implemented in various ways to use the NLP ML model 110 to automatically map a question or compliance controls associated with a compliance standard to compliance controls associated with another compliance standard, including being implemented in hardware, software, firmware, or any combination thereof. For example, the automatic compliance control mapping logic 108 may be implemented as computer program code configured to be executed in one or more processors. In another example, at least a portion of the automatic compliance control mapping logic 108 may be implemented as hardware logic/electrical circuitry. For instance, at least a portion of the automatic compliance control mapping logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

It will be recognized that the automatic compliance control mapping logic 108 may be (or may be included in) a cloud computing program, though the scope of the example embodiments is not limited in this respect.

The automatic compliance control mapping logic 108 and the NLP ML model 110 are shown to be incorporated in the first server(s) 106A for illustrative purposes and are not intended to be limiting. It will be recognized that the automatic compliance control mapping logic 108 (or any portion(s) thereof) may be incorporated in any one or more of the servers 106A-106N, any one or more of the user devices 102A-102M, or any combination thereof. For example, client-side aspects of the automatic compliance control mapping logic 108 may be incorporated in one or more of the user devices 102A-102M, and server-side aspects of automatic compliance control mapping logic 108 may be incorporated in one or more of the servers 106A-106N. It will be further recognized that the NLP ML model 110 (or any portion(s) thereof) may be incorporated in any one or more of the servers 106A-106N, any one or more of the user devices 102A-102M, or any combination thereof.

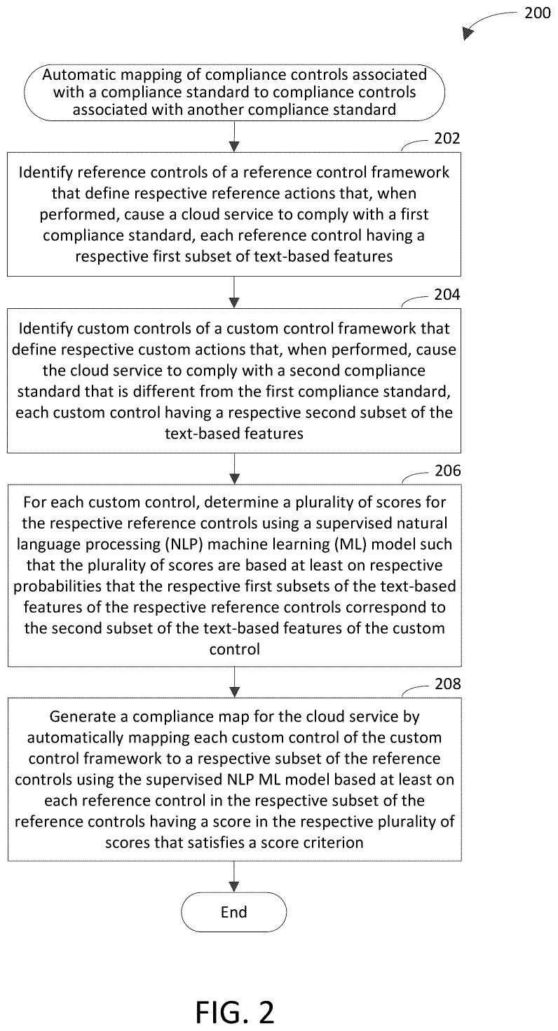

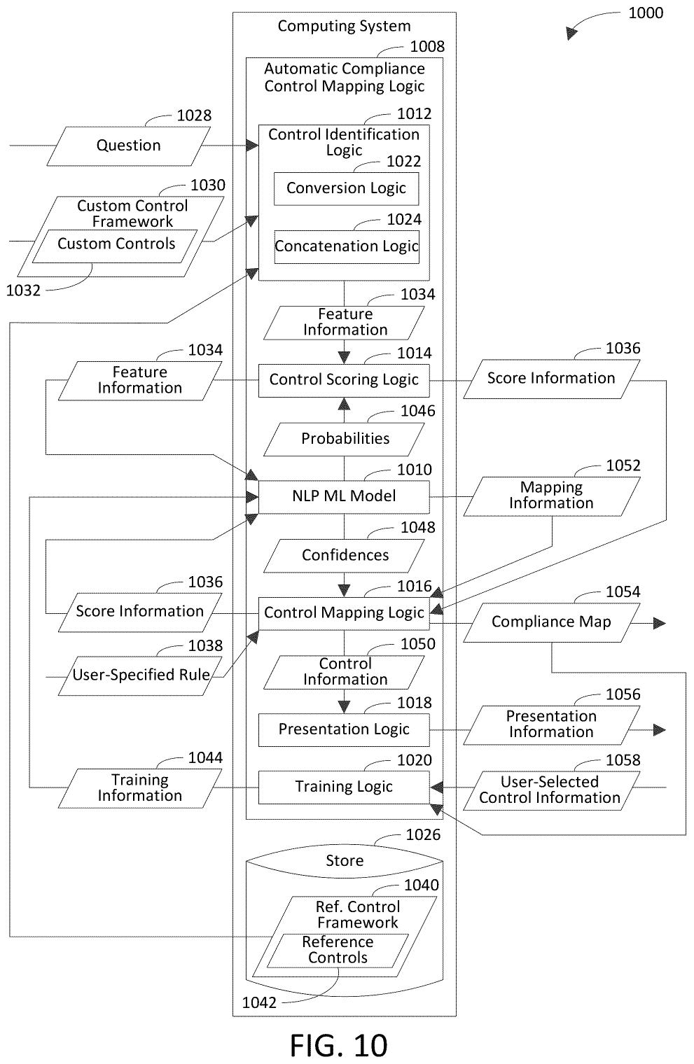

FIGS. 2-5 depict flowcharts 200, 300, 400, and 500 of example methods for automatically mapping compliance controls associated with a compliance standard to compliance controls associated with another compliance standard in accordance with embodiments. Flowcharts 200, 300, 400, and 500 may be performed by the first server(s) 106A shown in FIG. 1, for example. For illustrative purposes, flowcharts 200, 300, 400, and 500 are described with respect to computing system 1000 shown in FIG. 10, which is an example implementation of the first server(s) 106A. As shown in FIG. 10, the computing system 1000 includes automatic compliance control mapping logic 1008 and a store 1026. The automatic compliance control mapping logic 1008 includes NLP ML model 1010, control identification logic 1012, control scoring logic 1014, control mapping logic 1016, presentation logic 1018, and training logic 1020. The control identification logic 1012 includes conversion logic 1022 and concatenation logic 1024. The store 1026 may be any suitable type of store. One type of store is a database. For instance, the store 1026 may be a relational database, an entity-relationship database, an object database, an object relational database, an extensible markup language (XML) database, etc. The store 1026 is shown to store a reference control framework 1040, which includes reference controls 1042, for non-limiting, illustrative purposes. Further structural and operational embodiments will be apparent to persons skilled in the relevant art(s) based on the discussion regarding flowcharts 200, 300, 400, and 500.

As shown in FIG. 2, the method of flowchart 200 begins at step 202. In step 202, reference controls of a reference control framework are identified. The reference controls define respective reference actions that, when performed, cause a cloud service to comply with a first compliance standard. Each reference control has a respective first subset of text-based features such that each text-based feature in the respective first subset includes information regarding the reference control. Each text-based feature in each first subset of the text-based features may include any suitable information regarding the respective reference control, including but not limited to information indicating a control type in which the respective reference control is categorized, a title of the respective reference control, a description of functionality of the respective reference control, and information that indicates a manner in which the respective reference control is implemented.

In an example implementation, the control identification logic 1012 identifies the reference controls 1042 of the reference control framework 1040. The reference controls 1042 define respective reference actions that, when performed, cause the cloud service to comply with the first compliance standard. Each of the reference controls 1042 has a respective first subset of the text-based features. The control identification logic 1012 generates feature information 1034, which indicates the reference controls 1042 and the respective first subsets of the text-based features. For instance, the feature information 1034 may cross-reference the reference controls 1042 with the respective first subsets of the text-based features.

At step 204, custom controls of a custom control framework are identified. The custom controls define respective custom actions that, when performed, cause the cloud service to comply with a second compliance standard that is different from the first compliance standard. Each custom control has a respective second subset of the text-based features such that each text-based feature in the respective second subset includes information regarding the custom control. In an example implementation, the control identification logic 1012 identifies custom controls 1032 of a custom control framework 1030. The custom controls 1032 define respective custom actions that, when performed, cause the cloud service to comply with the second compliance standard. Each of the custom controls 1032 has a respective second subset of the text-based features. The control identification logic 1012 configures the feature information 1034 to indicate the custom controls 1032 and the respective second subsets of the text-based features. For instance, the feature information 1034 may cross-reference the custom controls 1032 with the respective second subsets of the text-based features.

At step 206, for each custom control, a plurality of scores (e.g., rankings) are determined for the respective reference controls using a supervised natural language processing (NLP) machine learning (ML) model such that the plurality of scores are based at least on respective probabilities that the respective first subsets of the text-based features of the respective reference controls correspond to (e.g., are semantically similar to) the second subset of the text-based features of the custom control.

In an example implementation, for each of the custom controls 1032, the control scoring logic 1014 determines scores for the respective reference controls 1042 using the NLP ML model 1010. In an aspect of this implementation, the control scoring logic 1014 provides (e.g., forwards) the feature information 1034 to the NLP ML model 1010 for analysis. In accordance with this aspect, the NLP ML model 1010 determines, for each custom control, probabilities that the respective first subsets of the text-based features of the respective reference controls 1042 correspond to the second subset of the text-based features of the custom control by analyzing the feature information 1034. The NLP ML model 1010 generates probabilities 1046, which include the probabilities associated with each of the custom controls 1032. In further accordance with this aspect, for each of the custom controls 1032, the control scoring logic 1014 determines the scores based at least on the probabilities that are associated with the respective custom control. For example, the control scoring logic 1014 may assign a first set of scores to the respective reference controls 1042 for a first custom control based at least on the probabilities that are associated with the first custom control. In accordance with this example, the control scoring logic 1014 may assign a second set of scores to the respective reference controls 1042 for a second custom control based at least on the probabilities that are associated with the second custom control, and so on. The control scoring logic 1014 generates score information 1036 to indicate, for each of the custom controls 1032, the scores for the respective reference controls 1042. For instance, for each of the custom controls 1032, the score information 1036 may cross-reference the reference controls 1042 with the respective scores.

At step 208, a compliance map is generated for the cloud service by automatically mapping each custom control of the custom control framework to a respective subset of the reference controls using the supervised NLP ML model based at least on each reference control in the respective subset of the reference controls having a score in the respective plurality of scores that satisfies a score criterion. For example, the score criterion may require that each reference control in each subset of the reference controls has a score in the respective plurality of scores that is greater than or equal to a score threshold. For instance, the score threshold may be a pre-defined score threshold and/or a fixed score threshold. In another example, the score criterion may require that each reference control in each subset of the reference controls has a score in the respective plurality of scores that is greater than a score in the respective plurality of scores for each reference control that is not included in the respective subset of the reference controls.

In an example implementation, the control mapping logic 1016 generates a compliance map 1054 for the cloud service by automatically mapping each of the custom controls 1032 of the custom control framework 1030 to a respective subset of the reference controls 1042 using the NLP ML model 1010 as a result of each reference control in the respective subset of the reference controls 1042 having a score in the respective plurality of scores that satisfies the score criterion. In an aspect of this implementation, the control mapping logic 1016 provides (e.g., forwards) the score information 1036 to the NLP ML model 1010 for processing. In accordance with this aspect, for each of the custom controls 1032, the NLP ML model 1010 determines the scores for the respective reference controls 1042 by analyzing the score information 1036. In further accordance with this aspect, for each of the custom controls 1032, the NLP ML model 1010 selects which of the reference controls 1042 are to be included in the respective subset of the reference controls 1042 based at least on the score of each reference control in the respective subset of the reference controls 1042 having a score that satisfies the score criterion. In further accordance with this aspect, the NLP ML model 1010 automatically maps each of the custom controls 1032 to the respective subset of the reference controls 1042. The NLP ML model 1010 generates mapping information 1052 to indicate the subset of the reference controls 1042 that is mapped to each of the custom controls 1032. In further accordance with this aspect, the control mapping logic 1016 configures the compliance map 1054 to indicate the subset of the reference controls 1042 that is mapped to each of the custom controls 1032 by analyzing the mapping information 1052.

In an example embodiment, the reference controls are relatively broad in scope, and the custom controls are relatively narrow in scope. For instance, the custom codes may be configured to satisfy the requirements of the reference controls. In one example implementation, a reference control requires data to be encrypted, and a corresponding custom code requires data at rest to be encrypted using a particular encryption algorithm. In accordance with this embodiment, the NLP ML model is capable of analyzing the custom control to determine that the custom control pertains to encryption and then mapping the custom control to the reference control based at least on a determination that the reference control pertains to encryption, as well.

In another example embodiment, contextual information regarding the reference controls is taken into account by including the self-loop of reference controls to a training dataset X that is used to train the NLP ML model. Accordingly, a question or custom control with the same text-based features as a reference control is mapped to the reference control. Hence, the mapping Z→Z (one-to-one mapping) is added to the training dataset, so that the training dataset becomes X′={X, Z} with mapping X′→Z. Updating the training data set in this manner may provide advantages as compared to conventional mapping techniques. For instance, the NLP ML model may be capable of considering the contextual information of reference controls when making predictions for new questions or custom controls that are not like any other questions or custom controls that have been processed by the NLP ML model. The NLP ML model may be capable of considering reference controls that have not been mapped to from known questions or custom controls when making suggestions. This embodiment may utilize similarity search between input nodes (e.g., questions and/or custom controls) and between input nodes and target nodes (e.g., reference controls) to achieve better results for multi-label classification problems.

In some example embodiments, one or more steps 202, 204, 206, and/or 208 of flowchart 200 may not be performed. Moreover, steps in addition to or in lieu of steps 202, 204, 206, and/or 208 may be performed. For instance, in an example embodiment, the method of flowchart 200 further includes receiving a user-specified rule, which indicates a maximum number of reference controls to be included in each subset of the reference controls to which a respective custom control is to be mapped. In an example implementation, the control mapping logic 1016 receives a user-specified rule 1038, which indicates the maximum number of reference controls to be included in each subset of the reference controls 1042 to which a respective custom control is to be mapped. In accordance with this embodiment, the method of flowchart 200 further includes, based at least on receipt of the user-specified rule, defining each subset of the reference controls to which a respective custom control is to be mapped to include no more than the maximum number of reference controls. In accordance with an example implementation, the control mapping logic 1016 limits the number of the reference controls 1042 in each subset to be no more than the maximum number indicated by the user-specified rule 1038. In an example, the user-specified rule may indicate a fixed number of reference controls to be included in each subset of the reference controls to which a respective custom control is to be mapped, and each subset of the reference controls may be defined to include the fixed number of reference controls.

In another example embodiment, the method of flowchart 200 further includes, for each custom control, determining confidences in the respective probabilities on which the plurality of respective scores are based. In an example implementation, the NLP ML model 1010 determines (e.g., calculates) confidences 1048 in the respective probabilities 1046 associated with each of the custom controls 1032 and provides the confidences 1048 to the control mapping logic 1016 for processing. In accordance with this embodiment, generating the compliance map at step 208 includes automatically mapping each custom control of the custom control framework to the respective subset of the reference controls using the supervised NLP ML model further based at least on the confidence in the probability associated with each reference control in the respective subset of the reference controls being greater than or equal to a confidence threshold. In an example implementation, the control mapping logic 1016 generates the compliance map 1054 by automatically mapping each of the custom controls 1032 to the respective subset of the reference controls 1042 using the NLP ML model 1010 further based at least on the confidence in the probability associated with each reference control in the respective subset of the reference controls 1042 being greater than or equal to the confidence threshold.

In yet another example embodiment, the method of flowchart 200 further includes training the NLP ML model using labels. Each label indicates a mapping of a custom control to a reference control. In an example implementation, the training logic 1020 trains the NLP ML model 1010 using the labels. For instance, the training logic 1020 may generate each label to indicate the mapping of the respective custom control to the respective reference control by analyzing the compliance map 1054 to identify the mapping. The training logic 1020 provides training information 1044, which includes the labels, to the NLP ML model 1010 for processing. In accordance with this embodiment, training the NLP ML model includes causing the NLP ML model to take into consideration dependencies between the labels by optimizing weights associated with the respective reference controls simultaneously for each custom control. For instance, by providing the training information 1044 to the NLP ML model 1010, the training logic 1020 may trigger the NLP ML model 1010 to optimize the weights associated with the respective reference controls simultaneously for each custom control, which results in the dependencies between the labels being taken into account.

In still another example embodiment, the method of flowchart 200 further includes causing a user interface to be presented. The user interface specifies each reference control in each subset of the reference controls that is mapped to a respective custom control of the custom control framework.

In a first aspect of this embodiment, the user interface enables a user to perform actions for each subset of the reference controls. The actions include approving inclusion of each reference control in the respective subset of the reference controls, removing each reference control from the respective subset of the reference controls, and adding a reference control to the respective subset of the reference controls. The user may be an information technology (IT) professional, such as an administrator of the cloud service.

In a second aspect of this embodiment, the user interface includes a first interface element, a second interface element, and a third interface element. The first interface element enables a user to include a reference control in each subset of the reference controls in training data that is used to train the supervised NLP ML model. The second interface element enables the user to exclude a reference control in each subset of the reference controls from the training data. The third interface element enables the user to add a reference control to each subset of the reference controls. The first interface element and the second interface element may be the same or different.

In an example implementation, the presentation logic 1018 causes the user interface to be presented. For instance, the presentation logic 1018 may generate presentation information 1056, which defines (e.g., includes) the user interface. The presentation logic 1018 may cause the user interface to be presented by providing the presentation information 1056 to a display device. In accordance with this implementation, the user interface specifies each reference control in each subset of the reference controls 1042 that is mapped to a respective custom control of the custom control framework 1030.

In an example embodiment, the method of flowchart 200 further includes identifying an additional control that is configured to enable the cloud service to further comply with the second compliance standard. In an example implementation, the control mapping logic 1016 identifies the additional control. The control mapping logic 1016 configures the control information 1050 to indicate the additional control. For instance, the control mapping logic 1016 may configure the control information 1050 to indicate that the additional control is capable of enabling the cloud service to further comply with the second compliance standard. In accordance with this embodiment, the method of flowchart 200 further includes causing a recommendation to be provided via a user interface. The recommendation recommends addition of the additional control to the custom control framework. In an example implementation, the presentation logic 1018 causes the recommendation to be provided via the user interface. The presentation logic 1018 generates the recommendation based on the control information indicating the additional control (e.g., based on the control information indicating that the additional control is capable of enabling the cloud service to further comply with the second compliance standard). The presentation logic 1018 may provide presentation information 1056, which includes information that defines the recommendation, to a display device to enable the recommendation to be provided by the user interface.

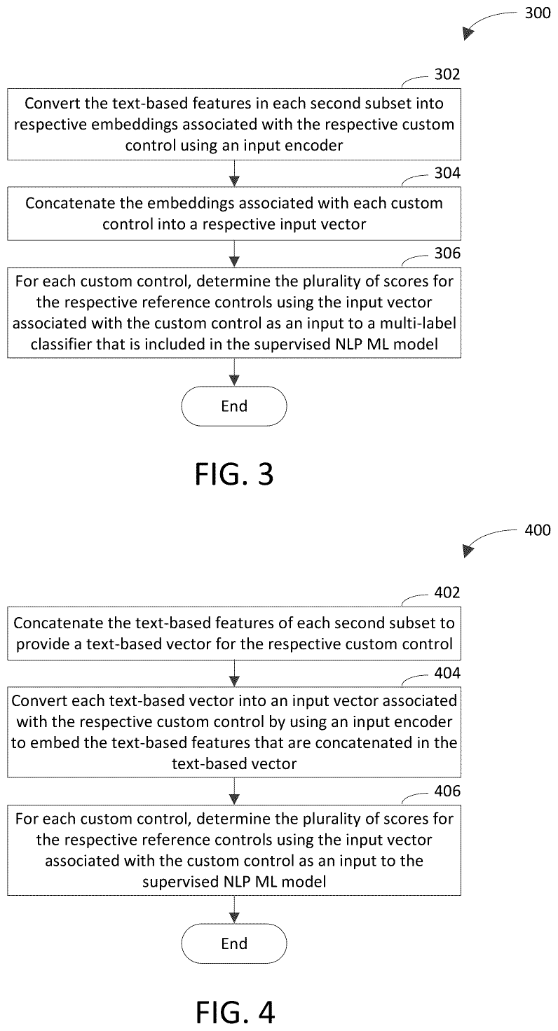

In another example embodiment, the method of flowchart 200 includes one or more of the steps shown in flowchart 300 of FIG. 3. As shown in FIG. 3, the method of flowchart 300 begins at step 302. In step 302, the text-based features in each second subset are converted into respective embeddings associated with the respective custom control using an input encoder. It will be recognized that each embedding may be a representation of an item that preserves connectivity and/or algebraic properties of the item. In an aspect, the input encoder is incorporated into the NLP ML model. In an example implementation, the conversion logic 1022 converts the text-based features in each second subset into the respective embeddings associated with the respective custom control using the input encoder.

At step 304, the embeddings associated with each custom control are concatenated into a respective input vector. In an example implementation, the concatenation logic 1024 concatenates the embeddings associated with each of the custom controls 1032 into a respective input vector. In accordance with this implementation, the concatenation logic 1024 configures the feature information 1034 to indicate the input vectors that are associated with the respective custom controls 1032.

At step 306, for each custom control, the plurality of scores for the respective reference controls are determined using the input vector associated with the custom control as an input to a multi-label classifier that is included in the supervised NLP ML model. An example of a multi-label classifier is a feedforward neural network built on top of a term frequency-inverse document frequency (TF-IDF) vectorizer or on top of a universal sentence encoder. In an aspect of this embodiment, step 306 is included in step 206 of FIG. 2. In an example implementation, for each of the custom controls 1032, the control scoring logic 1014 determines the plurality of scores for the respective reference controls 1042 using the input vector associated with the custom control as an input to the multi-label classifier, which is included in the NLP ML model 1010. In an aspect of this implementation, the control scoring logic 1014 provides the feature information 1034, which indicates the input vectors that are associated with the respective custom controls 1032, to the NLP ML model 1010 for processing. In accordance with this aspect, the NLP ML model 1010 generates the probabilities 1046, which include the probabilities associated with each of the custom controls 1032, based at least on the input vectors that are associated with the respective custom controls 1032, as indicated by the feature information 1034. In further accordance with this aspect, for each of the custom controls 1032, the control scoring logic 1014 determines the scores for the respective reference controls 1042 based at least on the probabilities associated with the respective custom control.

In yet another example embodiment, the method of flowchart 200 includes one or more of the steps shown in flowchart 400 of FIG. 4. As shown in FIG. 4, the method of flowchart 400 begins at step 402. In step 402, the text-based features of each second subset are concatenated to provide a text-based vector for the respective custom control. In an example implementation, the concatenation logic 1024 concatenates the text-based features of each second subset to provide the text-based vector for the respective custom control.

At step 404, each text-based vector is converted into an input vector associated with the respective custom control by using an input encoder to embed the text-based features that are concatenated in the text-based vector. In an aspect, the input encoder is incorporated into the NLP ML model. In an example implementation, the conversion logic 1022 converts each text-based vector into an input vector associated with the respective custom control by using the input encoder to embed the text-based features that are concatenated in the text-based vector. In accordance with this implementation, the conversion logic 1022 configures the feature information 1034 to indicate the input vectors that are associated with the respective custom controls 1032.

At step 406, for each custom control, the plurality of scores for the respective reference controls are determined using the input vector associated with the custom control as an input to the supervised NLP ML model. In an aspect of this embodiment, step 406 is included in step 206 of FIG. 2. In an example implementation, for each of the custom controls 1032, the control scoring logic 1014 determines the plurality of scores for the respective reference controls 1042 using the input vector associated with the custom control as an input to the NLP ML model 1010.

The multi-label classification techniques described herein (e.g., those described above with reference to FIGS. 3 and 4) provide advantages over conventional classification techniques. For instance, for multi-label classification with a large number of classes, simple classification (e.g., binary classification) approaches can become computationally expensive as separate binary classifiers are trained for each class (one-versus-all) or each pair of classes (one-versus-one). Simple binary classifiers treat class labels as independent target variables and may not be efficient for multi-label classification because they do not consider dependencies between labels. In multi-label scenarios, conventional multi-class classification models rely on the assumption that classes are mutually exclusive, which is not the case for multi-label classification problems. However, the multi-label classification techniques described herein are capable of taking into account dependencies between labels by optimizing weights associated with all classes at once for each example during training to efficiently achieve better (e.g., more efficient, accurate, precise, and/or reliable) performance. In an example embodiment, a neural network architecture serves as an encoder to learn better representations of the example in the hidden embeddings for the classifier layer (output layer) to achieve better results.

The output Q of the multi-label classifier is a vector of dimension N, where N is a number of all possible classes, (i.e., Q=[q_1, q_2, . . . , q_n]), where q_i represents the probability of the input example (e.g., question or custom control) mapping to class i. For each input example, the classes (e.g., reference controls) are then ranked by the associated output probability to determine the most relevant classes to which the input example should be mapped.

The user may determine the number of top suggested results (e.g., classes or controls) with the associated confidence score to display. To display the confidence score, a probability calibration may be performed on top of the output Q instead of showing the raw output probability scores q to user to better calibrate the confidence scores for user experience. This is because the mapping is sparse, and raw output the probabilities may be low and may require further calibration to be meaningful to user. The calibration may be performed by training a logistic regression layer on top of the output probabilities using a validation dataset that was set aside before the model training. The validation dataset may include pairs of an input node and output node with a label of whether the input node is truly mapped to the output node. The calibration model may take the output of the multi-label classifier for the validation dataset as input to train the NLP ML model to minimize the loss between the calibrated distribution and the true distribution. The calibrated output Q′ may be used as confidence scores to display to the user.

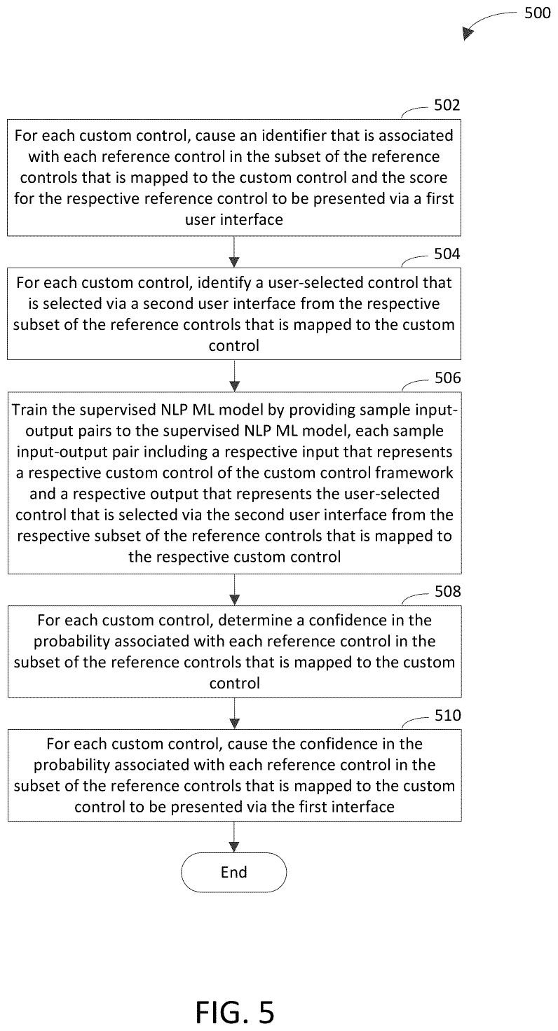

In still another example embodiment, the method of flowchart 200 further includes one or more of the steps shown in flowchart 500 of FIG. 5. As shown in FIG. 5, the method of flowchart 500 begins at step 502. In step 502, for each custom control, an identifier that is associated with each reference control in the subset of the reference controls that is mapped to the custom control and the score for the respective reference control are caused to be presented via a first user interface. In an example implementation, for each of the custom controls 1032, the presentation logic 1018 causes the identifier that is associated with each reference control in the subset of the reference controls 1042 that is mapped to the custom control and the score for the respective reference control to be presented via the first user interface. For instance, the presentation logic 1018 may configure the presentation information 1056 to indicate (e.g., include) the identifier associated with each reference control in the subset of the reference controls 1042 that is mapped to the custom control and the score for the respective reference control.

At step 504, for each custom control, a user-selected control that is selected via a second user interface from the respective subset of the reference controls that is mapped to the custom control is identified. The first user interface and the second user interface may be the same or different. In an example implementation, for each of the custom controls 1032, the training logic 1020 identifies the user-selected control that is selected via the second user interface from the respective subset of the reference controls that is mapped to the respective custom control. For instance, the training logic 1020 may analyze user-selected control information 1058, which indicates the user-selected controls associated with the respective custom controls 1032, to identify the respective user-selected controls.

At step 506, the supervised NLP ML model is trained by providing sample input-output pairs to the supervised NLP ML model. Each sample input-output pair includes a respective input that represents a respective custom control of the custom control framework and a respective output that represents the user-selected control that is selected via the second user interface from the respective subset of the reference controls that is mapped to the respective custom control. In an example implementation, the training logic 1020 trains the NLP ML model 1010 by providing the sample input-output pairs to the NLP ML model 1010. For instance, the training logic 1020 may configure the training information 1044 to indicate the sample input-output pairs.

At step 508, for each custom control, a confidence in the probability associated with each reference control in the subset of the reference controls that is mapped to the custom control is determined. In an example implementation, for each of the custom controls 1032, the control mapping logic 1016 determines the confidence in the probability associated with each reference control in the subset of the reference controls that is mapped to the custom control. In an aspect, the NLP ML model 1010 calculates the confidences 1048 in the respective probabilities 1046 associated with each of the custom controls 1032 and provides the confidences 1048 to the control mapping logic 1016 for processing. In accordance with this aspect, the control mapping logic 1016 determines the confidences 1048 as a result of receiving the confidences 1048 from the NLP ML model 1010. In further accordance with this aspect, the control mapping logic 1016 configures the control information 1050 to indicate the confidences 1048 in the respective probabilities 1046 associated with each of the custom controls 1032.

At step 510, for each custom control, the confidence in the probability associated with each reference control in the subset of the reference controls that is mapped to the custom control is caused to be presented via the first interface. In an example implementation, for each of the custom controls 1032, the presentation logic 1018 causes the confidence in the probability associated with each reference control in the subset of the reference controls 1042 that is mapped to the custom control to be presented via the first interface. For instance, the presentation logic 1018 may analyze the control information 1050 to determine the confidences 1048 in the respective probabilities 1046 associated with each of the custom controls 1032. In accordance with this implementation, the presentation logic 1018 configures the presentation information 1056 to indicate the confidence in the probability associated with each reference control in the subset of the reference controls that is mapped to each custom control.

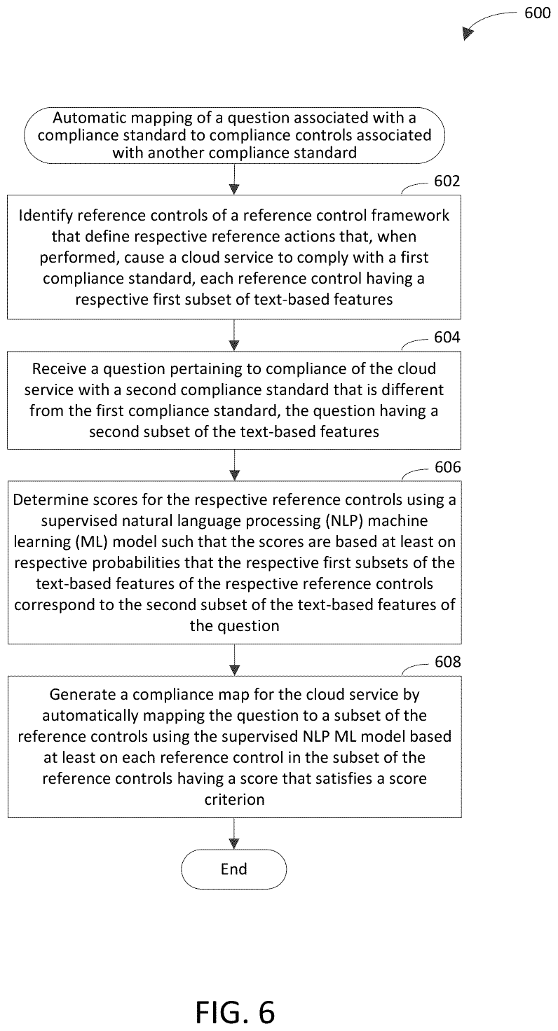

FIGS. 6-9 depict flowcharts 600, 700, 800, and 900 of example methods for automatically mapping a question associated with a compliance standard to compliance controls associated with another compliance standard in accordance with embodiments. Flowcharts 600, 700, 800, and 900 may be performed by the first server(s) 106A shown in FIG. 1, for example. For illustrative purposes, flowcharts 600, 700, 800, and 900 are described with respect to computing system 1000 shown in FIG. 10, which is an example implementation of the first server(s) 106A. Further structural and operational embodiments will be apparent to persons skilled in the relevant art(s) based on the discussion regarding flowcharts 600, 700, 800, and 900.

As shown in FIG. 6, the method of flowchart 600 begins at step 602. In step 602, reference controls of a reference control framework are identified. The reference controls define respective reference actions that, when performed, cause a cloud service to comply with a first compliance standard. Each reference control has a respective first subset of text-based features such that each text-based feature in the respective first subset includes information regarding the reference control. Each text-based feature in each first subset of the text-based features may include any suitable information regarding the respective reference control, including but not limited to information indicating a control type in which the respective reference control is categorized, a title of the respective reference control, a description of functionality of the respective reference control, and information that indicates a manner in which the respective reference control is implemented.

In an example implementation, the control identification logic 1012 identifies the reference controls 1042 of the reference control framework 1040. The reference controls 1042 define respective reference actions that, when performed, cause the cloud service to comply with the first compliance standard. Each of the reference controls 1042 has a respective first subset of the text-based features. The control identification logic 1012 generates feature information 1034, which indicates the reference controls 1042 and the respective first subsets of the text-based features. For instance, the feature information 1034 may cross-reference the reference controls 1042 with the respective first subsets of the text-based features.

At step 604, a question pertaining to compliance of the cloud service with a second compliance standard that is different from the first compliance standard is received. The question has a second subset of the text-based features such that each text-based feature in the second subset includes information regarding the question. For instance, the information regarding the question may be a portion of the question, such as a word in the question. In an example implementation, the control identification logic 1012 receives a question 1028 pertaining to compliance of the cloud service with the second compliance standard. The question 1028 has the second subset of the text-based features such that each text-based feature in the second subset includes information regarding the question 1028. The control identification logic 1012 configures the feature information 1034 to indicate the second subset of the text-based features. The control identification logic 1012 may further configure the feature information 1034 to indicate the question 1028. For instance, the feature information 1034 may associate the question 1028 with the second subset of the text-based features.

At step 606, scores (e.g., rankings) are determined for the respective reference controls using a supervised natural language processing (NLP) machine learning (ML) model such that the scores are based at least on respective probabilities that the respective first subsets of the text-based features of the respective reference controls correspond to (e.g., are semantically similar to) the second subset of the text-based features of the question. In an example implementation, the control scoring logic 1014 determines scores for the respective reference controls 1042 using the NLP ML model 1010. In an aspect of this implementation, the control scoring logic 1014 provides (e.g., forwards) the feature information 1034 to the NLP ML model 1010 for analysis. In accordance with this aspect, the NLP ML model 1010 determines probabilities that the respective first subsets of the text-based features of the respective reference controls 1042 correspond to the second subset of the text-based features of the question 1028 by analyzing the feature information 1034. The NLP ML model 1010 generates probabilities 1046, which include the probabilities associated with the respective first subsets of the text-based features. In further accordance with this aspect, the control scoring logic 1014 determines the scores based at least on the probabilities associated with the respective first subsets of the text-based features. The control scoring logic 1014 generates score information 1036 to indicate the scores for the respective reference controls 1042. For instance, the score information 1036 may cross-reference the reference controls 1042 with the respective scores.

At step 608, a compliance map is generated for the cloud service by automatically mapping the question to a subset of the reference controls using the supervised NLP ML model based at least on each reference control in the subset of the reference controls having a score that satisfies a score criterion. For example, the score criterion may require that each reference control in the subset of the reference controls has a score that is greater than or equal to a score threshold. For instance, the score threshold may be a pre-defined score threshold and/or a fixed score threshold.

In an example implementation, the control mapping logic 1016 generates a compliance map 1054 for the cloud service by automatically mapping the question 1028 to a subset of the reference controls 1042 using the NLP ML model 1010 as a result of each reference control in the subset of the reference controls 1042 having a score that satisfies the score criterion. In an aspect of this implementation, the control mapping logic 1016 provides (e.g., forwards) the score information 1036 to the NLP ML model 1010 for processing. In accordance with this aspect, the NLP ML model 1010 determines the scores for the respective reference controls 1042 by analyzing the score information 1036. In further accordance with this aspect, the NLP ML model 1010 selects which of the reference controls 1042 are to be included in the subset of the reference controls 1042 based at least on the score of each reference control in the subset of the reference controls 1042 having a score that satisfies the score criterion. In further accordance with this aspect, the NLP ML model 1010 automatically maps the question 1028 to the subset of the reference controls 1042. The NLP ML model 1010 generates mapping information 1052 to indicate the subset of the reference controls 1042 that is mapped to the question 1028. In further accordance with this aspect, the control mapping logic 1016 configures the compliance map 1054 to indicate the subset of the reference controls 1042 that is mapped to the question 1028 by analyzing the mapping information 1052.

In some example embodiments, one or more steps 602, 604, 606, and/or 608 of flowchart 600 may not be performed. Moreover, steps in addition to or in lieu of steps 602, 604, 606, and/or 608 may be performed. For instance, in an example embodiment, the method of flowchart 600 further includes receiving a user-specified rule, which indicates a maximum number of reference controls to be included in the subset of the reference controls to which the question is to be mapped. In an example implementation, the control mapping logic 1016 receives a user-specified rule 1038, which indicates the maximum number of reference controls to be included in the subset of the reference controls 1042 to which the question 1028 is to be mapped. In accordance with this embodiment, the method of flowchart 600 further includes, based at least on receipt of the user-specified rule, defining the subset of the reference controls to which the question is to be mapped to include no more than the maximum number of reference controls. In accordance with an example implementation, the control mapping logic 1016 limits the number of the reference controls 1042 in the subset to be no more than the maximum number indicated by the user-specified rule 1038. In an example, the user-specified rule may indicate a fixed number of reference controls to be included in the subset of the reference controls to which the question is to be mapped, and the subset of the reference controls may be defined to include the fixed number of reference controls.

In another example embodiment, the method of flowchart 600 further includes determining confidences in the respective probabilities on which the plurality of respective scores are based. In an example implementation, the NLP ML model 1010 determines (e.g., calculates) confidences 1048 in the respective probabilities 1046 and provides the confidences 1048 to the control mapping logic 1016 for processing. In accordance with this embodiment, generating the compliance map at step 608 includes automatically mapping question to the subset of the reference controls using the supervised NLP ML model further based at least on the confidence in the probability associated with each reference control in the subset of the reference controls being greater than or equal to a confidence threshold. In an example implementation, the control mapping logic 1016 generates the compliance map 1054 by automatically mapping question 1028 to the subset of the reference controls 1042 using the NLP ML model 1010 further based at least on the confidence in the probability associated with each reference control in the subset of the reference controls 1042 being greater than or equal to the confidence threshold.

In yet another example embodiment, the method of flowchart 600 further includes training the NLP ML model using labels. Each label indicates a mapping of a question to a reference control. Each question pertains to compliance of the cloud service with a compliance standard. In an example implementation, the training logic 1020 trains the NLP ML model 1010 using the labels. For instance, the training logic 1020 may generate each label to indicate the mapping of the respective question to the respective reference control by analyzing the compliance map 1054 to identify the mapping. The training logic 1020 provides training information 1044, which includes the labels, to the NLP ML model 1010 for processing. In accordance with this embodiment, training the NLP ML model includes causing the NLP ML model to take into consideration dependencies between the labels by optimizing weights associated with the respective reference controls simultaneously. For instance, by providing the training information 1044 to the NLP ML model 1010, the training logic 1020 may trigger the NLP ML model 1010 to optimize the weights associated with the respective reference controls simultaneously, which results in the dependencies between the labels being taken into account.

In still another example embodiment, the method of flowchart 600 further includes causing a user interface to be presented. The user interface specifies each reference control in the subset of the reference controls that is mapped to the question.

In a first aspect of this embodiment, the user interface enables a user to perform actions for the subset of the reference controls. The actions include approving inclusion of each reference control in the subset of the reference controls, removing each reference control from the subset of the reference controls, and adding a reference control to the subset of the reference controls. The user may be an information technology (IT) professional, such as an administrator of the cloud service.

In a second aspect of this embodiment, the user interface includes a first interface element, a second interface element, and a third interface element. The first interface element enables a user to include a reference control in the subset of the reference controls in training data that is used to train the supervised NLP ML model. The second interface element enables the user to exclude a reference control in the subset of the reference controls from the training data. The third interface element enables the user to add a reference control to the subset of the reference controls. The first interface element and the second interface element may be the same or different.

In an example implementation, the presentation logic 1018 causes the user interface to be presented. For instance, the presentation logic 1018 may generate presentation information 1056, which defines (e.g., includes) the user interface. The presentation logic 1018 may cause the user interface to be presented by providing the presentation information 1056 to a display device. In accordance with this implementation, the user interface specifies each reference control in the subset of the reference controls 1042 that is mapped to the question 1028.

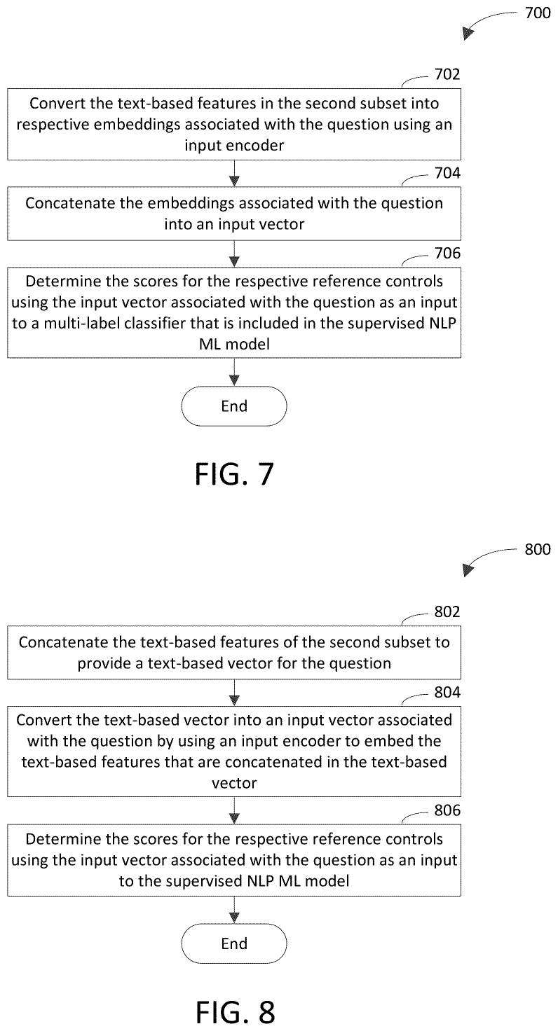

In an example embodiment, the method of flowchart 600 includes one or more of the steps shown in flowchart 700 of FIG. 7. As shown in FIG. 7, the method of flowchart 700 begins at step 702. In step 702, the text-based features in the second subset are converted into respective embeddings associated with the question using an input encoder. It will be recognized that each embedding may be a representation of an item that preserves connectivity and/or algebraic properties of the item. In an aspect, the input encoder is incorporated into the NLP ML model. In an example implementation, the conversion logic 1022 converts the text-based features in the second subset into the respective embeddings associated with the question 1028 using the input encoder.

At step 704, the embeddings associated with the question are concatenated into an input vector. In an example implementation, the concatenation logic 1024 concatenates the embeddings associated with the question 1028 into the input vector. In accordance with this implementation, the concatenation logic 1024 configures the feature information 1034 to indicate the input vector that is associated with the question 1028.

At step 706, the scores for the respective reference controls are determined using the input vector associated with the question as an input to a multi-label classifier that is included in the supervised NLP ML model. An example of a multi-label classifier is a feedforward neural network built on top of a term frequency-inverse document frequency (TF-IDF) vectorizer or on top of a universal sentence encoder. In an aspect of this embodiment, step 706 is included in step 606 of FIG. 6. In an example implementation, the control scoring logic 1014 determines the scores for the respective reference controls 1042 using the input vector associated with the question 1028 as an input to the multi-label classifier, which is included in the NLP ML model 1010. In an aspect of this implementation, the control scoring logic 1014 provides the feature information 1034, which indicates the input vector that is associated with the question 1028, to the NLP ML model 1010 for processing. In accordance with this aspect, the NLP ML model 1010 generates the probabilities 1046, which include the probabilities associated with the respective first subsets of the text-based features, based at least on the input vector that is associated with the question 1028, as indicated by the feature information 1034. In further accordance with this aspect, the control scoring logic 1014 determines the scores for the respective reference controls 1042 based at least on the probabilities associated with the respective first subsets of the text-based features.

In another example embodiment, the method of flowchart 600 includes one or more of the steps shown in flowchart 800 of FIG. 8. As shown in FIG. 8, the method of flowchart 800 begins at step 802. In step 802, the text-based features of the second subset are concatenated to provide a text-based vector for the question. In an example implementation, the concatenation logic 1024 concatenates the text-based features of the second subset to provide the text-based vector for the question 1028.

At step 804, the text-based vector is converted into an input vector associated with the question by using an input encoder to embed the text-based features that are concatenated in the text-based vector. In an aspect, the input encoder is incorporated into the NLP ML model. In an example implementation, the conversion logic 1022 converts the text-based vector into an input vector associated with the question 1028 by using the input encoder to embed the text-based features that are concatenated in the text-based vector. In accordance with this implementation, the conversion logic 1022 configures the feature information 1034 to indicate the input vector that is associated with the question 1028.

At step 806, the scores for the respective reference controls are determined using the input vector associated with the question as an input to the supervised NLP ML model. In an aspect of this embodiment, step 806 is included in step 606 of FIG. 6. In an example implementation, the control scoring logic 1014 determines the scores for the respective reference controls 1042 using the input vector associated with the question 1028 as an input to the NLP ML model 1010.

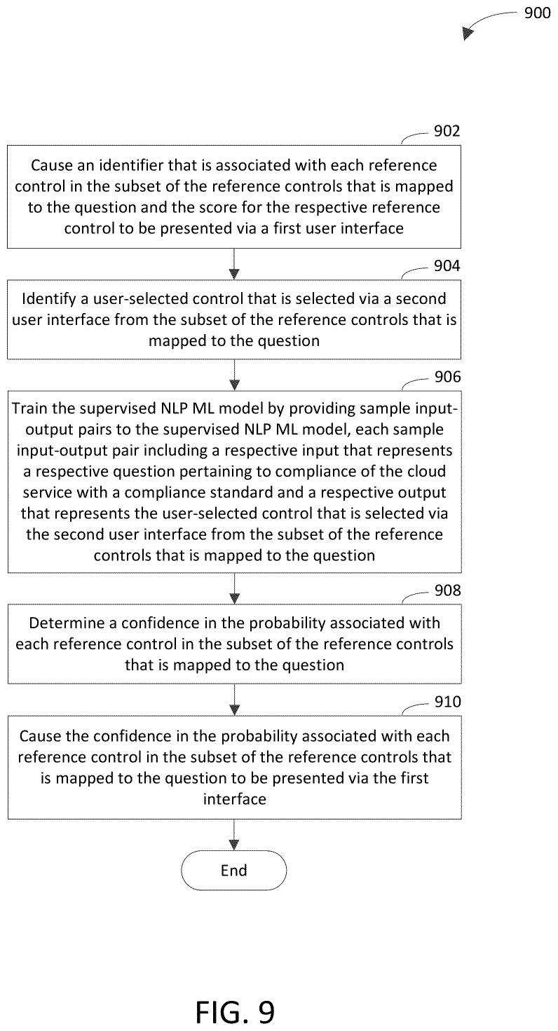

In yet another example embodiment, the method of flowchart 600 further includes one or more of the steps shown in flowchart 900 of FIG. 9. As shown in FIG. 9, the method of flowchart 900 begins at step 902. In step 902, an identifier that is associated with each reference control in the subset of the reference controls that is mapped to the question and the score for the respective reference control are caused to be presented via a first user interface. In an example implementation, the presentation logic 1018 causes the identifier that is associated with each reference control in the subset of the reference controls 1042 that is mapped to the question 1028 and the score for the respective reference control to be presented via the first user interface. For instance, the presentation logic 1018 may configure the presentation information 1056 to indicate (e.g., include) the identifier associated with each reference control in the subset of the reference controls 1042 that is mapped to the question 1028 and the score for the respective reference control.

At step 904, a user-selected control that is selected via a second user interface from the subset of the reference controls that is mapped to the question is identified. The first user interface and the second user interface may be the same or different. In an example implementation, the training logic 1020 identifies the user-selected control that is selected via the second user interface from the subset of the reference controls that is mapped to the question 1028. For instance, the training logic 1020 may analyze user-selected control information 1058, which indicates the selected user-selected control, to identify the user-selected control.

At step 906, the supervised NLP ML model is trained by providing sample input-output pairs to the supervised NLP ML model. Each sample input-output pair includes a respective input that represents a respective question pertaining to compliance of the cloud service with a compliance standard and a respective output that represents the user-selected control that is selected via the second user interface from the subset of the reference controls that is mapped to the question. In an example implementation, the training logic 1020 trains the NLP ML model 1010 by providing the sample input-output pairs to the NLP ML model 1010. For instance, the training logic 1020 may configure the training information 1044 to indicate the sample input-output pairs.

At step 908, a confidence in the probability associated with each reference control in the subset of the reference controls that is mapped to the question is determined. In an example implementation, the control mapping logic 1016 determines the confidence in the probability associated with each reference control in the subset of the reference controls that is mapped to the question 1028. In an aspect, the NLP ML model 1010 calculates the confidences 1048 in the respective probabilities 1046 associated with the question 1028 and provides the confidences 1048 to the control mapping logic 1016 for processing. In accordance with this aspect, the control mapping logic 1016 determines the confidences 1048 as a result of receiving the confidences 1048 from the NLP ML model 1010. In further accordance with this aspect, the control mapping logic 1016 configures the control information 1050 to indicate the confidences 1048 in the respective probabilities 1046 associated with the question 1028.

At step 910, the confidence in the probability associated with each reference control in the subset of the reference controls that is mapped to the question is caused to be presented via the first interface. In an example implementation, the presentation logic 1018 causes the confidence in the probability associated with each reference control in the subset of the reference controls 1042 that is mapped to the question 1028 to be presented via the first interface. For instance, the presentation logic 1018 may analyze the control information 1050 to determine the confidences 1048 in the respective probabilities 1046 associated with the question 1028. In accordance with this implementation, the presentation logic 1018 configures the presentation information 1056 to indicate the confidence in the probability associated with each reference control in the subset of the reference controls that is mapped to the question 1028.

It will be recognized that the computing system 1000 may not include one or more of the automatic compliance control mapping logic 1008, the NLP ML model 1010, the control identification logic 1012, the control scoring logic 1014, the control mapping logic 1016, the presentation logic 1018, the training logic 1020, the conversion logic 1022, the concatenation logic 1024, and/or the store 1026. Furthermore, the computing system 1000 may include components in addition to or in lieu of the automatic compliance control mapping logic 1008, the NLP ML model 1010, the control identification logic 1012, the control scoring logic 1014, the control mapping logic 1016, the presentation logic 1018, the training logic 1020, the conversion logic 1022, the concatenation logic 1024, and/or the store 1026.

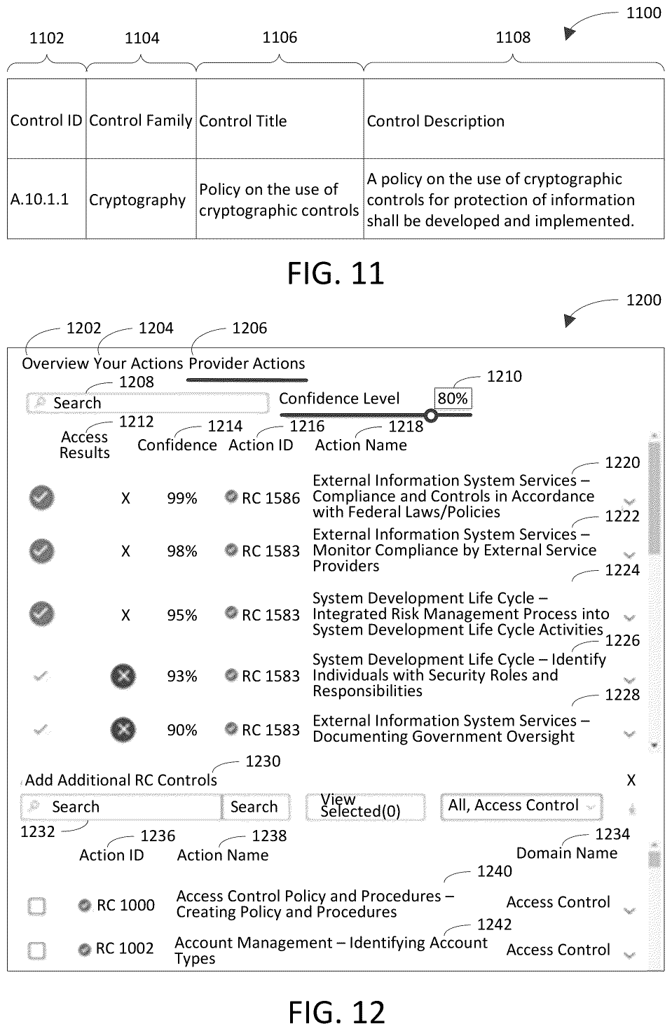

FIG. 11 depicts an example compliance control 1100 in accordance with an embodiment. The compliance control 1100 has a first text-based feature 1102, a second text-based feature 1104, a third text-based feature 1106, and a fourth text-based feature 1108. The first text-based feature 1102 indicates (e.g., includes) a control identifier (ID) of the compliance control 1100. The control ID identifies the compliance control 1100 and is listed as “A.10.1.1” for illustrative purposes. The second text-based feature 1104 indicates a control family of the compliance control 1100. The control family is a category to which the compliance control 1100 is assigned and is listed as “Cryptography” for illustrative purposes. The third text-based feature 1106 indicates a control title, which is the title of the compliance control 1100. The control title is listed as “Policy on the user of cryptographic controls” for illustrative purposes. The fourth text-based feature 1108 indicates a control description, which describes functionality of the compliance control 1100. The control description is listed as “A policy on the use of cryptographic controls for protection of information shall be developed and implemented” for illustrative purposes.

FIG. 12 depicts an example user interface 1200 in accordance with an embodiment. The user interface 1200 includes a first selector interface element 1202, a second selector interface element 1204, and a third selector interface element 1206. Selection of the first selector interface element 1202 enables a user to view information regarding all reference controls associated with a first compliance standard that correspond to a question or custom control(s) associated with a second compliance standard. Selection of the second selector interface element 1204 enables the user to view information regarding the reference controls that define respective user actions and not information regarding the reference controls that define respective provider actions. A user action is an action that is to be performed by the user (e.g., rather than by a provider associated with the reference controls) to facilitate compliance with the second compliance standard. A provider action is an action that is to be performed by the provider associated with the reference controls (e.g., rather than by the user) to facilitate compliance with the second compliance standard. Selection of the third selector interface element 1206 enables the user to view information regarding the reference controls that define respective provider actions and not information regarding the reference controls that define the respective user actions.

The third selector interface element 1206 is shown to be selected in FIG. 12 for illustrative purposes, which results in information regarding the reference controls that define the respective provider actions, including provider actions 1220, 1222, 1224, 1226 and 1228, being listed in the user interface 1200.

An access indicator 1212, a confidence 1214, an action ID 1216, and an action name 1218 are provided for each of the provider actions 1220, 1222, 1224, 1226, and 1228. Each access indicator 1212 indicates whether the respective reference control is to be included among the subset(s) of the reference controls that are mapped to the question or the custom control(s) for purposes of generating a compliance map. For instance, the reference controls that define the provider actions 1220, 1222, and 1224 are selected to be included in the subset(s), whereas the reference controls that define the provider actions 1227 and 1228 are de-selected so that they are excluded from the subset(s). Each confidence indicator 1214 indicates a confidence that the respective reference control corresponds to the question or the custom control(s). Each action ID 1216 identifies the respective reference control or the action defined by the respective reference control. Each action name 1218 indicates the name of the respective reference control or the action defined by the respective reference control.

The user interface 1200 includes a search box 1208 into which the user may enter textual search criteria to perform a search with regard to the reference controls that are displayed in response to selection of the first, second, or third selector interface element 1202, 1204, or 1206. A confidence interface element 1210 enables the user to set a confidence threshold so that only reference controls having a confidence greater than or equal to the confidence threshold are displayed in response to selection of the first, second, or third selector interface element 1202, 1204, or 1206. The confidence of each reference control represents a confidence in a determined probability that the reference control corresponds to the question or the custom code(s).

The user interface 1200 includes an “Add Additional RC Controls” section 1230, which provides information regarding additional reference controls that are not included in the subset(s) of the reference controls that are to be mapped to the question or the custom control(s). The additional reference controls define respective additional provider actions, including additional provider actions 1240 and 1242. The user may select any of the additional reference controls to be included in the subset(s) of the reference controls that are mapped to the question or the custom control(s).

An action ID 1236, an action name 1238, and a domain name 1234 are provided for each of the additional provider actions 1240 and 1242. Each action ID 1236 identifies the respective additional reference control or the action defined by the respective additional reference control. Each action name 1238 indicates the name of the respective additional reference control or the action defined by the respective additional reference control. Each domain name 1234 indicates a domain (e.g., category) to which the respective additional reference control is assigned.

The user interface 1200 includes another search box 1230 into which the user may enter textual search criteria to perform a search with regard to the additional reference controls.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the automatic compliance control mapping logic 108, the automatic compliance control mapping logic 1008, the NLP ML model 1010, the control identification logic 1012, the control scoring logic 1014, the control mapping logic 1016, the presentation logic 1018, the training logic 1020, the conversion logic 1022, the concatenation logic 1024, flowchart 200, flowchart 300, flowchart 400, flowchart 500, flowchart 600, flowchart 700, flowchart 800, and/or flowchart 900 may be implemented in hardware, software, firmware, or any combination thereof.

For example, any one or more of the automatic compliance control mapping logic 108, the automatic compliance control mapping logic 1008, the NLP ML model 1010, the control identification logic 1012, the control scoring logic 1014, the control mapping logic 1016, the presentation logic 1018, the training logic 1020, the conversion logic 1022, the concatenation logic 1024, flowchart 200, flowchart 300, flowchart 400, flowchart 500, flowchart 600, flowchart 700, flowchart 800, and/or flowchart 900 may be implemented, at least in part, as computer program code configured to be executed in one or more processors.

In another example, any one or more of the automatic compliance control mapping logic 108, the automatic compliance control mapping logic 1008, the NLP ML model 1010, the control identification logic 1012, the control scoring logic 1014, the control mapping logic 1016, the presentation logic 1018, the training logic 1020, the conversion logic 1022, the concatenation logic 1024, flowchart 200, flowchart 300, flowchart 400, flowchart 500, flowchart 600, flowchart 700, flowchart 800, and/or flowchart 900 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

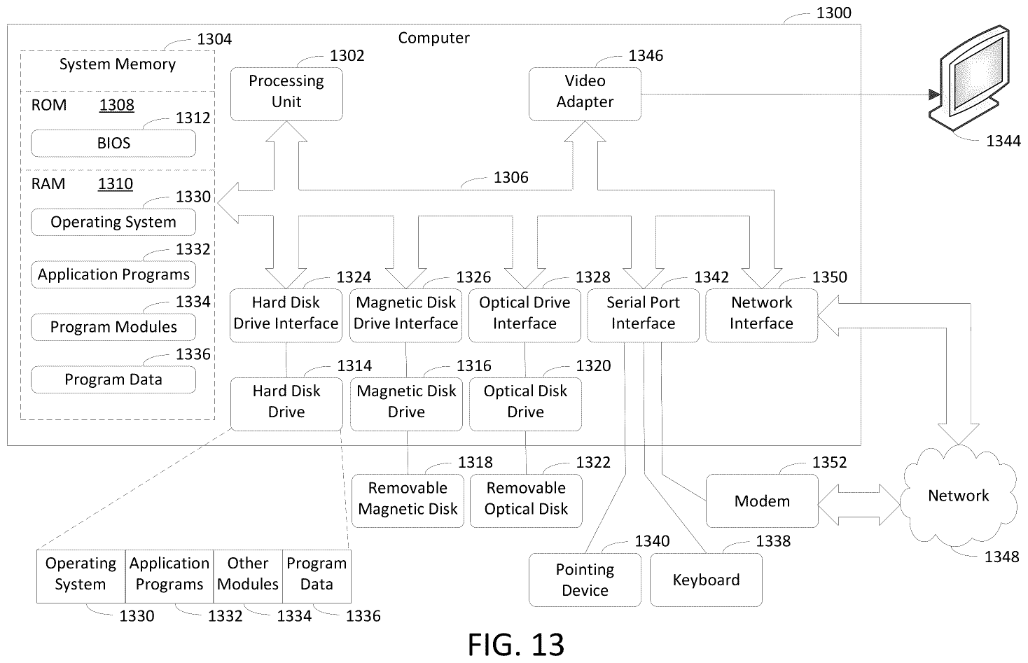

(A1) A first example system (FIG. 1, 102A-102M, 106A-106N; FIG. 10, 1000; FIG. 13, 1300) comprises memory (FIG. 13, 1304, 1308, 1310) and a processing system (FIG. 13, 1302) coupled to the memory. The processing system is configured to identify (FIG. 2, 202) reference controls (FIG. 10, 1042) of a reference control framework (FIG. 10, 1032) that define respective reference actions that, when performed, cause a cloud service to comply with a first compliance standard. Each reference control has a respective first subset of text-based features such that each text-based feature in the respective first subset includes information regarding the reference control. The processing system is further configured to identify (FIG. 2, 204) custom controls (FIG. 10, 1032) of a custom control framework (FIG. 10, 1030) that define respective custom actions that, when performed, cause the cloud service to comply with a second compliance standard that is different from the first compliance standard. Each custom control has a respective second subset of the text-based features such that each text-based feature in the respective second subset includes information regarding the custom control. The processing system is further configured to, for each custom control, determine (FIG. 2, 206) a plurality of scores for the respective reference controls using a supervised natural language processing machine learning model (FIG. 10, 1010) such that the plurality of scores are based at least on respective probabilities (FIG. 10, 1046) that the respective first subsets of the text-based features of the respective reference controls correspond to the second subset of the text-based features of the custom control. The processing system is further configured to generate (FIG. 2, 208) a compliance map (FIG. 10, 1054) for the cloud service by automatically mapping each custom control of the custom control framework to a respective subset of the reference controls using the supervised natural language processing machine learning model based at least on each reference control in the respective subset of the reference controls having a score in the respective plurality of scores that satisfies a score criterion.

(A2) In the example system of A1, wherein the processing system is configured to: convert the text-based features in each second subset into respective embeddings associated with the respective custom control using an input encoder; concatenate the embeddings associated with each custom control into a respective input vector; and for each custom control, determine the plurality of scores for the respective reference controls using the input vector associated with the custom control as an input to a multi-label classifier that is included in the supervised natural language processing machine learning model.

(A3) In the example system of any of A1-A2, wherein the processing system is configured to: concatenate the text-based features of each second subset to provide a text-based vector for the respective custom control; convert each text-based vector into an input vector associated with the respective custom control by using an input encoder to embed the text-based features that are concatenated in the text-based vector; and for each custom control, determine the plurality of scores for the respective reference controls using the input vector associated with the custom control as an input to the supervised natural language processing machine learning model.

(A4) In the example system of any of A1-A3, wherein the processing system is configured to: generate the compliance map for the cloud service by automatically mapping each custom control of the custom control framework to the respective subset of the reference controls using the supervised natural language processing machine learning model based at least on each reference control in the respective subset of the reference controls having a score in the respective plurality of scores that is greater than or equal to a score threshold.

(A5) In the example system of any of A1-A4, wherein the processing system is further configured to: based at least on receipt of a user-specified rule, which indicates a maximum number of reference controls to be included in each subset of the reference controls to which a respective custom control is to be mapped, define each subset of the reference controls to which a respective custom control is to be mapped to include no more than the maximum number of reference controls.

(A6) In the example system of any of A1-A5, wherein the processing system is configured to: for each custom control, determine confidences in the respective probabilities on which the plurality of respective scores are based; and generate the compliance map for the cloud service by automatically mapping each custom control of the custom control framework to the respective subset of the reference controls using the supervised natural language processing machine learning model further based at least on the confidence in the probability associated with each reference control in the respective subset of the reference controls being greater than or equal to a confidence threshold.

(A7) In the example system of any of A1-A6, wherein the processing system is further configured to: for each custom control, cause an identifier that is associated with each reference control in the subset of the reference controls that is mapped to the custom control and the score for the respective reference control to be presented via a first user interface; for each custom control, identify a user-selected control that is selected via a second user interface from the respective subset of the reference controls that is mapped to the custom control; and train the supervised natural language processing machine learning model by providing sample input-output pairs to the supervised natural language processing machine learning model, each sample input-output pair including a respective input that represents a respective custom control of the custom control framework and a respective output that represents the user-selected control that is selected via the second user interface from the respective subset of the reference controls that is mapped to the respective custom control.

(A8) In the example system of any of A1-A7, wherein the processing system is further configured to: for each custom control, determine a confidence in the probability associated with each reference control in the subset of the reference controls that is mapped to the custom control; and for each custom control, cause the confidence in the probability associated with each reference control in the subset of the reference controls that is mapped to the custom control to be presented via the first interface.

(A9) In the example system of any of A1-A8, wherein the processing system is further configured to: train the NLP ML model using labels, which includes causing the NLP ML model to take into consideration dependencies between the labels by optimizing weights associated with the respective reference controls simultaneously for each custom control; and wherein each of the labels indicates a mapping of a custom control to a reference control.

(A10) In the example system of any of A1-A9, wherein the first subset of text-based features of each reference control indicates at least one of the following: a control type in which the reference control is categorized; a title of the reference control; a description of functionality of the reference control; a manner in which the reference control is implemented.

(A11) In the example system of any of A1-A10, wherein the processing system is further configured to: cause a user interface to be presented, the user interface specifying each reference control in each subset of the reference controls that is mapped to a respective custom control of the custom control framework, the user interface enabling a user to perform the following actions for each subset of the reference controls: approve inclusion of each reference control in the subset of the reference controls; remove each reference control from the subset of the reference controls; and add a reference control to the subset of the reference controls.

(A12) In the example system of any of A1-A11, wherein the processing system is further configured to: cause a user interface to be presented, the user interface specifying each reference control in each subset of the reference controls that is mapped to a respective custom control of the custom control framework, the user interface comprising: a first interface element that enables a user to include a reference control in each subset of the reference controls in training data that is used to train the supervised natural language processing machine learning model; a second interface element that enables the user to exclude a reference control in each subset of the reference controls from the training data; a third interface element that enables the user to add a reference control to each subset of the reference controls.

(A13) In the example system of any of A1-A12, wherein the processing system is further configured to: identify an additional control that is configured to enable the cloud service to further comply with the second compliance standard; and cause a recommendation to be provided via a user interface, the recommendation recommending addition of the additional control to the custom control framework.

(B1) A second example system (FIG. 1, 102A-102M, 106A-106N; FIG. 10, 1000; FIG. 13, 1300) comprises memory (FIG. 13, 1304, 1308, 1310) and a processing system (FIG. 13, 1302) coupled to the memory. The processing system is configured to identify (FIG. 6, 602) reference controls (FIG. 10, 1042) of a reference control framework (FIG. 10, 1040) that define respective reference actions that, when performed, cause a cloud service to comply with a first compliance standard. Each reference control has a respective first subset of text-based features such that each text-based feature in the respective first subset includes information regarding the reference control. The processing system is further configured to receive (FIG. 6, 604) a question (FIG. 10, 1028) pertaining to compliance of the cloud service with a second compliance standard that is different from the first compliance standard. The question has a second subset of the text-based features such that each text-based feature in the second subset includes information regarding the question. The processing system is further configured to determine (FIG. 6, 606) scores for the respective reference controls using a supervised natural language processing machine learning model (FIG. 10, 1010) such that the scores are based at least on respective probabilities (FIG. 10, 1046) that the respective first subsets of the text-based features of the respective reference controls correspond to the second subset of the text-based features of the question. The processing system is further configured to generate (FIG. 6, 608) a compliance map (FIG. 10, 1054) for the cloud service by automatically mapping the question to a subset of the reference controls using the supervised natural language processing machine learning model based at least on each reference control in the subset of the reference controls having a score that satisfies a score criterion.

(B2) In the example system of B1, wherein the processing system is configured to: convert the text-based features in the second subset into respective embeddings associated with the question using an input encoder; concatenate the embeddings associated with the question into an input vector; and determine the scores for the respective reference controls using the input vector associated with the question as an input to a multi-label classifier that is included in the supervised natural language processing machine learning model.

(B3) In the example system of any of B1-B2, wherein the processing system is configured to: concatenate the text-based features of the second subset to provide a text-based vector for the question; convert the text-based vector into an input vector associated with the question by using an input encoder to embed the text-based features that are concatenated in the text-based vector; and determine the scores for the respective reference controls using the input vector associated with the question as an input to the supervised natural language processing machine learning model.

(B4) In the example system of any of B1-B3, wherein the processing system is configured to: generate the compliance map for the cloud service by automatically mapping the question to the subset of the reference controls using the supervised natural language processing machine learning model based at least on each reference control in the subset of the reference controls having a score that is greater than or equal to a score threshold.

(B5) In the example system of any of B1-B4, wherein the processing system is further configured to: based at least on receipt of a user-specified rule, which indicates a maximum number of reference controls to be included in the subset of the reference controls to which the question is to be mapped, define the subset of the reference controls to which the question is to be mapped to include no more than the maximum number of reference controls.

(B6) In the example system of any of B1-B5, wherein the processing system is configured to: determine confidences in the respective probabilities on which the plurality of respective scores are based; and generate the compliance map for the cloud service by automatically mapping the question to the subset of the reference controls using the supervised natural language processing machine learning model further based at least on the confidence in the probability associated with each reference control in the subset of the reference controls being greater than or equal to a confidence threshold.

(B7) In the example system of any of B1-B6, wherein the processing system is further configured to: cause an identifier that is associated with each reference control in the subset of the reference controls that is mapped to the question and the score for the respective reference control to be presented via a first user interface; identify a user-selected control that is selected via a second user interface from the subset of the reference controls that is mapped to the question; and train the supervised natural language processing machine learning model by providing sample input-output pairs to the supervised natural language processing machine learning model, each sample input-output pair including a respective input that represents a respective question pertaining to compliance of the cloud service with a compliance standard and a respective output that represents the user-selected control that is selected via the second user interface from the subset of the reference controls that is mapped to the question.

(B8) In the example system of any of B1-B7, wherein the processing system is further configured to: determine a confidence in the probability associated with each reference control in the subset of the reference controls that is mapped to the question; and cause the confidence in the probability associated with each reference control in the subset of the reference controls that is mapped to the question to be presented via the first interface.

(B9) In the example system of any of B1-B8, wherein the processing system is further configured to: train the NLP ML model using labels, which includes causing the NLP ML model to take into consideration dependencies between the labels by optimizing weights associated with the respective reference controls simultaneously; wherein each label indicates a mapping of a question to a reference control; and wherein each question pertains to compliance of the cloud service with a compliance standard.

(B10) In the example system of any of B1-B9, wherein the first subset of text-based features of each reference control indicates at least one of the following: a control type in which the reference control is categorized; a title of the reference control; a description of functionality of the reference control; a manner in which the reference control is implemented.

(B11) In the example system of any of B1-B10, wherein the processing system is further configured to: cause a user interface to be presented, the user interface specifying each reference control in the subset of the reference controls that is mapped to the question, the user interface enabling a user to perform the following actions: approve inclusion of each reference control in the subset of the reference controls; remove each reference control from the subset of the reference controls; and add a reference control to the subset of the reference controls.

(B12) In the example system of any of B1-B11, wherein the processing system is further configured to: cause a user interface to be presented, the user interface specifying each reference control in the subset of the reference controls that is mapped to the question, the user interface comprising: a first interface element that enables a user to include a reference control in the subset of the reference controls in training data that is used to train the supervised natural language processing machine learning model; a second interface element that enables the user to exclude a reference control in the subset of the reference controls from the training data; a third interface element that enables the user to add a reference control to the subset of the reference controls.

(C1) A first example method is implemented by a computing system (FIG. 1, 102A-102M, 106A-106N; FIG. 10, 1000; FIG. 13, 1300). The method comprises identifying (FIG. 2, 202) reference controls (FIG. 10, 1042) of a reference control framework that define respective reference actions that, when performed, cause a cloud service to comply with a first compliance standard. Each reference control has a respective first subset of text-based features such that each text-based feature in the respective first subset includes information regarding the reference control. The method further comprises identifying (FIG. 2, 204) custom controls (FIG. 10, 1032) of a custom control framework (FIG. 10, 1030) that define respective custom actions that, when performed, cause the cloud service to comply with a second compliance standard that is different from the first compliance standard. Each custom control has a respective second subset of the text-based features such that each text-based feature in the respective second subset includes information regarding the custom control. The method further comprises, for each custom control, determining (FIG. 2, 206) a plurality of scores for the respective reference controls using a supervised natural language processing machine learning model (FIG. 10, 1010) such that the plurality of scores are based at least on respective probabilities (FIG. 10, 1046) that the respective first subsets of the text-based features of the respective reference controls correspond to the second subset of the text-based features of the custom control. The method further comprises generating (FIG. 2, 208) a compliance map (FIG. 10, 1054) for the cloud service by automatically mapping each custom control of the custom control framework to a respective subset of the reference controls using the supervised natural language processing machine learning model based at least on each reference control in the respective subset of the reference controls having a score in the respective plurality of scores that satisfies a score criterion.

(C2) In the method of C1, further comprising: converting the text-based features in each second subset into respective embeddings associated with the respective custom control using an input encoder; and concatenating the embeddings associated with each custom control into a respective input vector; wherein, for each custom control, determining the plurality of scores for the respective reference controls comprises: for each custom control, determining the plurality of scores for the respective reference controls using the input vector associated with the custom control as an input to a multi-label classifier that is included in the supervised natural language processing machine learning model.

(C3) In the method of any of C1-C2, further comprising: concatenating the text-based features of each second subset to provide a text-based vector for the respective custom control; and converting each text-based vector into an input vector associated with the respective custom control by using an input encoder to embed the text-based features that are concatenated in the text-based vector; wherein, for each custom control, determining the plurality of scores for the respective reference controls comprises: for each custom control, determining the plurality of scores for the respective reference controls using the input vector associated with the custom control as an input to the supervised natural language processing machine learning model.

(C4) In the method of any of C1-C3, wherein generating the compliance map comprises: automatically mapping each custom control of the custom control framework to the respective subset of the reference controls using the supervised natural language processing machine learning model based at least on each reference control in the respective subset of the reference controls having a score in the respective plurality of scores that is greater than or equal to a score threshold.

(C5) In the method of any of C1-C4, further comprising: receiving a user-specified rule, which indicates a maximum number of reference controls to be included in each subset of the reference controls to which a respective custom control is to be mapped; and based at least on receipt of the user-specified rule, defining each subset of the reference controls to which a respective custom control is to be mapped to include no more than the maximum number of reference controls.

(C6) In the method of any of C1-C5, further comprising: for each custom control, determining confidences in the respective probabilities on which the plurality of respective scores are based; wherein generating the compliance map comprises: automatically mapping each custom control of the custom control framework to the respective subset of the reference controls using the supervised natural language processing machine learning model further based at least on the confidence in the probability associated with each reference control in the respective subset of the reference controls being greater than or equal to a confidence threshold.

(C7) In the method of any of C1-C6, further comprising: for each custom control, causing an identifier that is associated with each reference control in the subset of the reference controls that is mapped to the custom control and the score for the respective reference control to be presented via a first user interface; for each custom control, identifying a user-selected control that is selected via a second user interface from the respective subset of the reference controls that is mapped to the custom control; and training the supervised natural language processing machine learning model by providing sample input-output pairs to the supervised natural language processing machine learning model, each sample input-output pair including a respective input that represents a respective custom control of the custom control framework and a respective output that represents the user-selected control that is selected via the second user interface from the respective subset of the reference controls that is mapped to the respective custom control.

(C8) In the method of any of C1-C7, further comprising: for each custom control, determining a confidence in the probability associated with each reference control in the subset of the reference controls that is mapped to the custom control; and for each custom control, causing the confidence in the probability associated with each reference control in the subset of the reference controls that is mapped to the custom control to be presented via the first interface.

(C9) In the method of any of C1-C8, further comprising: training the NLP ML model using labels, each label indicating a mapping of a custom control to a reference control; wherein training the NLP ML model comprises: causing the NLP ML model to take into consideration dependencies between the labels by optimizing weights associated with the respective reference controls simultaneously for each custom control.

(C10) In the method of any of C1-C9, wherein the first subset of text-based features of each reference control indicates at least one of the following: a control type in which the reference control is categorized; a title of the reference control; a description of functionality of the reference control; a manner in which the reference control is implemented.

(C11) In the method of any of C1-C10, further comprising: causing a user interface to be presented, the user interface specifying each reference control in each subset of the reference controls that is mapped to a respective custom control of the custom control framework, the user interface enabling a user to perform the following actions for each subset of the reference controls: approve inclusion of each reference control in the subset of the reference controls; remove each reference control from the subset of the reference controls; and add a reference control to the subset of the reference controls.

(C12) In the method of any of C1-C11, further comprising: causing a user interface to be presented, the user interface specifying each reference control in each subset of the reference controls that is mapped to a respective custom control of the custom control framework, the user interface comprising: a first interface element that enables a user to include a reference control in each subset of the reference controls in training data that is used to train the supervised natural language processing machine learning model; a second interface element that enables the user to exclude a reference control in each subset of the reference controls from the training data; a third interface element that enables the user to add a reference control to each subset of the reference controls.

(C13) In the method of any of C1-C12, further comprising: identifying an additional control that is configured to enable the cloud service to further comply with the second compliance standard; and causing a recommendation to be provided via a user interface, the recommendation recommending addition of the additional control to the custom control framework.

(D1) A second example method is implemented by a computing system (FIG. 1, 102A-102M, 106A-106N; FIG. 10, 1000; FIG. 13, 1300). The method comprises identifying (FIG. 6, 602) reference controls (FIG. 10, 1042) of a reference control framework (FIG. 10, 1040) that define respective reference actions that, when performed, cause a cloud service to comply with a first compliance standard. Each reference control has a respective first subset of text-based features such that each text-based feature in the respective first subset includes information regarding the reference control. The method further comprises receiving (FIG. 6, 604) a question (FIG. 10, 1028) pertaining to compliance of the cloud service with a second compliance standard that is different from the first compliance standard. The question has a second subset of the text-based features such that each text-based feature in the second subset includes information regarding the question. The method further comprises determining (FIG. 6, 606) scores for the respective reference controls using a supervised natural language processing machine learning model (FIG. 10, 1010) such that the scores are based at least on respective probabilities (FIG. 10, 1046) that the respective first subsets of the text-based features of the respective reference controls correspond to the second subset of the text-based features of the question. The method further comprises generating (FIG. 6, 608) a compliance map (FIG. 10, 1054) for the cloud service by automatically mapping the question to a subset of the reference controls using the supervised natural language processing machine learning model based at least on each reference control in the subset of the reference controls having a score that satisfies a score criterion.

(D2) In the method of D1, further comprising: converting the text-based features in the second subset into respective embeddings associated with the question using an input encoder; and concatenating the embeddings associated with the question into an input vector; wherein determining the scores for the respective reference controls comprises: determining the scores for the respective reference controls using the input vector associated with the question as an input to a multi-label classifier that is included in the supervised natural language processing machine learning model.

(D3) In the method of any of D1-D2, further comprising: concatenating the text-based features of the second subset to provide a text-based vector for the question; and converting the text-based vector into an input vector associated with the question by using an input encoder to embed the text-based features that are concatenated in the text-based vector; wherein determining the scores for the respective reference controls comprises: determining the scores for the respective reference controls using the input vector associated with the question as an input to the supervised natural language processing machine learning model.

(D4) In the method of any of D1-D3, wherein generating the compliance map comprises: automatically mapping the question to the subset of the reference controls using the supervised natural language processing machine learning model based at least on each reference control in the subset of the reference controls having a score that is greater than or equal to a score threshold.

(D5) In the method of any of D1-D4, further comprising: receiving a user-specified rule, which indicates a maximum number of reference controls to be included in the subset of the reference controls to which the question is to be mapped; and based at least on receipt of the user-specified rule, defining the subset of the reference controls to which the question is to be mapped to include no more than the maximum number of reference controls.

(D6) In the method of any of D1-D5, further comprising: determining confidences in the respective probabilities on which the plurality of respective scores are based; wherein generating the compliance map comprises: automatically mapping the question to the subset of the reference controls using the supervised natural language processing machine learning model further based at least on the confidence in the probability associated with each reference control in the subset of the reference controls being greater than or equal to a confidence threshold.

(D7) In the method of any of D1-D6, further comprising: causing an identifier that is associated with each reference control in the subset of the reference controls that is mapped to the question and the score for the respective reference control to be presented via a first user interface; identifying a user-selected control that is selected via a second user interface from the subset of the reference controls that is mapped to the question; and training the supervised natural language processing machine learning model by providing sample input-output pairs to the supervised natural language processing machine learning model, each sample input-output pair including a respective input that represents a respective question pertaining to compliance of the cloud service with a compliance standard and a respective output that represents the user-selected control that is selected via the second user interface from the subset of the reference controls that is mapped to the question.

(D8) In the method of any of D1-D7, further comprising: determining a confidence in the probability associated with each reference control in the subset of the reference controls that is mapped to the question; and causing the confidence in the probability associated with each reference control in the subset of the reference controls that is mapped to the question to be presented via the first interface.

(D9) In the method of any of D1-D8, further comprising: training the NLP ML model using labels, each label indicating a mapping of a question to a reference control, each question pertaining to compliance of the cloud service with a compliance standard; wherein training the NLP ML model comprises: causing the NLP ML model to take into consideration dependencies between the labels by optimizing weights associated with the respective reference controls simultaneously.

(D10) In the method of any of D1-D9, wherein the first subset of text-based features of each reference control indicates at least one of the following: a control type in which the reference control is categorized; a title of the reference control; a description of functionality of the reference control; a manner in which the reference control is implemented.

(D11) In the method of any of D1-D10, further comprising: causing a user interface to be presented, the user interface specifying each reference control in the subset of the reference controls that is mapped to the question, the user interface enabling a user to perform the following actions: approve inclusion of each reference control in the subset of the reference controls; remove each reference control from the subset of the reference controls; and add a reference control to the subset of the reference controls.

(D12) In the method of any of D1-D11, further comprising: causing a user interface to be presented, the user interface specifying each reference control in the subset of the reference controls that is mapped to the question, the user interface comprising: a first interface element that enables a user to include a reference control in the subset of the reference controls in training data that is used to train the supervised natural language processing machine learning model; a second interface element that enables the user to exclude a reference control in the subset of the reference controls from the training data; a third interface element that enables the user to add a reference control to the subset of the reference controls.

(E1) A first example computer program product (FIG. 13, 1318, 1322) comprising a computer-readable storage medium having instructions recorded thereon for enabling a processor-based system (FIG. 1, 102A-102M, 106A-106N; FIG. 10, 1000; FIG. 13, 1300) to perform operations. The operations comprise identifying (FIG. 2, 202) reference controls (FIG. 10, 1042) of a reference control framework (FIG. 10, 1040) that define respective reference actions that, when performed, cause a cloud service to comply with a first compliance standard. Each reference control has a respective first subset of text-based features such that each text-based feature in the respective first subset includes information regarding the reference control. The operations further comprise identifying (FIG. 2, 204) custom controls (FIG. 10, 1032) of a custom control framework (FIG. 10, 1030) that define respective custom actions that, when performed, cause the cloud service to comply with a second compliance standard that is different from the first compliance standard. Each custom control has a respective second subset of the text-based features such that each text-based feature in the respective second subset includes information regarding the custom control. The operations further comprise, for each custom control, determining (FIG. 2, 206) a plurality of scores for the respective reference controls using a supervised natural language processing machine learning model (FIG. 10, 1010) such that the plurality of scores are based at least on respective probabilities (FIG. 10, 1046) that the respective first subsets of the text-based features of the respective reference controls correspond to the second subset of the text-based features of the custom control. The operations further comprise generating (FIG. 2, 208) a compliance map (FIG. 10, 1054) for the cloud service by automatically mapping each custom control of the custom control framework to a respective subset of the reference controls using the supervised natural language processing machine learning model based at least on each reference control in the respective subset of the reference controls having a score in the respective plurality of scores that satisfies a score criterion.

(F1) A second example computer program product (FIG. 13, 1318, 1322) comprising a computer-readable storage medium having instructions recorded thereon for enabling a processor-based system (FIG. 1, 102A-102M, 106A-106N; FIG. 10, 1000; FIG. 13, 1300) to perform operations. The operations comprise identifying (FIG. 6, 602) reference controls (FIG. 10, 1042) of a reference control framework (FIG. 10, 1040) that define respective reference actions that, when performed, cause a cloud service to comply with a first compliance standard. Each reference control has a respective first subset of text-based features such that each text-based feature in the respective first subset includes information regarding the reference control. The operations further comprise receiving (FIG. 6, 604) a question (FIG. 10, 1028) pertaining to compliance of the cloud service with a second compliance standard that is different from the first compliance standard. The question has a second subset of the text-based features such that each text-based feature in the second subset includes information regarding the question. The operations further comprise determining (FIG. 6, 606) scores for the respective reference controls using a supervised natural language processing machine learning model (FIG. 10, 1010) such that the scores are based at least on respective probabilities (FIG. 10, 1046) that the respective first subsets of the text-based features of the respective reference controls correspond to the second subset of the text-based features of the question. The operations further comprise generating (FIG. 6, 608) a compliance map (FIG. 10, 1054) for the cloud service by automatically mapping the question to a subset of the reference controls using the supervised natural language processing machine learning model based at least on each reference control in the subset of the reference controls having a score that satisfies a score criterion.

### III. Example Computer System

FIG. 13 depicts an example computer 1300 in which embodiments may be implemented. Any one or more of the user devices 132A-102M and/or any one or more of the servers 106A-106N shown in FIG. 1 and/or the computing system 1000 shown in FIG. 10 may be implemented using computer 1300, including one or more features of computer 1300 and/or alternative features. Computer 1300 may be a general-purpose computing device in the form of a conventional personal computer, a mobile computer, or a workstation, for example, or computer 1300 may be a special purpose computing device. The description of computer 1300 provided herein is provided for purposes of illustration, and is not intended to be limiting. Embodiments may be implemented in further types of computer systems, as would be known to persons skilled in the relevant art(s).

As shown in FIG. 13, computer 1300 includes a processing unit 1302, a system memory 1304, and a bus 1306 that couples various system components including system memory 1304 to processing unit 1302. Bus 1306 represents one or more of any of several types of bus structures, including a memory bus or memory controller, a peripheral bus, an accelerated graphics port, and a processor or local bus using any of a variety of bus architectures. System memory 1304 includes read only memory (ROM) 1308 and random access memory (RAM) 1310. A basic input/output system 1312 (BIOS) is stored in ROM 1308.

Computer 1300 also has one or more of the following drives: a hard disk drive 1314 for reading from and writing to a hard disk, a magnetic disk drive 1316 for reading from or writing to a removable magnetic disk 1318, and an optical disk drive 1320 for reading from or writing to a removable optical disk 1322 such as a CD ROM, DVD ROM, or other optical media. Hard disk drive 1314, magnetic disk drive 1316, and optical disk drive 1320 are connected to bus 1306 by a hard disk drive interface 1324, a magnetic disk drive interface 1326, and an optical drive interface 1328, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1330, one or more application programs 1332, other program modules 1334, and program data 1336. Application programs 1332 or program modules 1334 may include, for example, computer program logic for implementing any one or more of (e.g., at least a portion of) the automatic compliance control mapping logic 108, the automatic compliance control mapping logic 1008, the NLP ML model 1010, the control identification logic 1012, the control scoring logic 1014, the control mapping logic 1016, the presentation logic 1018, the training logic 1020, the conversion logic 1022, the concatenation logic 1024, flowchart 200 (including any step of flowchart 200), flowchart 300 (including any step of flowchart 300), flowchart 400 (including any step of flowchart 400), flowchart 500 (including any step of flowchart 500), flowchart 600 (including any step of flowchart 600), flowchart 700 (including any step of flowchart 700), flowchart 800 (including any step of flowchart 800), and/or flowchart 900 (including any step of flowchart 900), as described herein.

A user may enter commands and information into the computer 1300 through input devices such as keyboard 1338 and pointing device 1340. Other input devices (not shown) may include a microphone, joystick, game pad, satellite dish, scanner, touch screen, camera, accelerometer, gyroscope, or the like. These and other input devices are often connected to the processing unit 1302 through a serial port interface 1342 that is coupled to bus 1306, but may be connected by other interfaces, such as a parallel port, game port, or a universal serial bus (USB).

A display device 1344 (e.g., a monitor) is also connected to bus 1306 via an interface, such as a video adapter 1346. In addition to display device 1344, computer 1300 may include other peripheral output devices (not shown) such as speakers and printers.

Computer 1300 is connected to a network 1348 (e.g., the Internet) through a network interface or adapter 1350, a modem 1352, or other means for establishing communications over the network. Modem 1352, which may be internal or external, is connected to bus 1306 via serial port interface 1342.

As used herein, the terms “computer program medium” and “computer-readable storage medium” are used to generally refer to media (e.g., non-transitory media) such as the hard disk associated with hard disk drive 1314, removable magnetic disk 1318, removable optical disk 1322, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 1332 and other program modules 1334) may be stored on the hard disk, magnetic disk, optical disk, ROM, or RAM. Such computer programs may also be received via network interface 1350 or serial port interface 1342. Such computer programs, when executed or loaded by an application, enable computer 1300 to implement features of embodiments discussed herein. Accordingly, such computer programs represent controllers of the computer 1300.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
memory; and
a processing system coupled to the memory, the processing system configured to:
identify reference controls of a reference control framework that define respective reference actions that, when performed, cause a cloud service to comply with a first compliance standard, each reference control having a respective first subset of text-based features such that each text-based feature in the respective first subset includes information regarding the reference control;
identify custom controls of a custom control framework that define respective custom actions that, when performed, cause the cloud service to comply with a second compliance standard that is different from the first compliance standard, each custom control having a respective second subset of the text-based features such that each text-based feature in the respective second subset includes information regarding the custom control;
for each custom control, determine a plurality of scores for the respective reference controls using a supervised natural language processing machine learning model such that the plurality of scores are based at least on respective probabilities that the respective first subsets of the text-based features of the respective reference controls correspond to the second subset of the text-based features of the custom control; and
generate a compliance map for the cloud service by automatically mapping each custom control of the custom control framework to a respective subset of the reference controls using the supervised natural language processing machine learning model based at least on each reference control in the respective subset of the reference controls having a score in the respective plurality of scores that satisfies a score criterion.

2. The system of claim 1, wherein the processing system is configured to:
convert the text-based features in each second subset into respective embeddings associated with the respective custom control using an input encoder;
concatenate the embeddings associated with each custom control into a respective input vector; and
for each custom control, determine the plurality of scores for the respective reference controls using the input vector associated with the custom control as an input to a multi-label classifier that is included in the supervised natural language processing machine learning model.

3. The system of claim 1, wherein the processing system is configured to:
concatenate the text-based features of each second subset to provide a text-based vector for the respective custom control;
convert each text-based vector into an input vector associated with the respective custom control by using an input encoder to embed the text-based features that are concatenated in the text-based vector; and
for each custom control, determine the plurality of scores for the respective reference controls using the input vector associated with the custom control as an input to the supervised natural language processing machine learning model.

4. The system of claim 1, wherein the processing system is further configured to:
based at least on receipt of a user-specified rule, which indicates a maximum number of reference controls to be included in each subset of the reference controls to which a respective custom control is to be mapped, define each subset of the reference controls to which a respective custom control is to be mapped to include no more than the maximum number of reference controls.

5. The system of claim 1, wherein the processing system is configured to:
for each custom control, determine confidences in the respective probabilities on which the plurality of respective scores are based; and
generate the compliance map for the cloud service by automatically mapping each custom control of the custom control framework to the respective subset of the reference controls using the supervised natural language processing machine learning model further based at least on the confidence in the probability associated with each reference control in the respective subset of the reference controls being greater than or equal to a confidence threshold.

6. The system of claim 1, wherein the processing system is further configured to:
for each custom control, cause an identifier that is associated with each reference control in the subset of the reference controls that is mapped to the custom control and the score for the respective reference control to be presented via a first user interface;
for each custom control, identify a user-selected control that is selected via a second user interface from the respective subset of the reference controls that is mapped to the custom control; and
train the supervised natural language processing machine learning model by providing sample input-output pairs to the supervised natural language processing machine learning model, each sample input-output pair including a respective input that represents a respective custom control of the custom control framework and a respective output that represents the user-selected control that is selected via the second user interface from the respective subset of the reference controls that is mapped to the respective custom control.

7. The system of claim 1, wherein the processing system is further configured to:
train the NLP ML model using labels, which includes causing the NLP ML model to take into consideration dependencies between the labels by optimizing weights associated with the respective reference controls simultaneously for each custom control; and
wherein each of the labels indicates a mapping of a custom control to a reference control.

8. The system of claim 1, wherein the first subset of text-based features of each reference control indicates at least one of the following:
a control type in which the reference control is categorized;
a title of the reference control;
a description of functionality of the reference control;
a manner in which the reference control is implemented.

9. The system of claim 1, wherein the processing system is further configured to:
cause a user interface to be presented, the user interface specifying each reference control in each subset of the reference controls that is mapped to a respective custom control of the custom control framework, the user interface enabling a user to perform the following actions for each subset of the reference controls:
approve inclusion of each reference control in the subset of the reference controls;
remove each reference control from the subset of the reference controls; and
add a reference control to the subset of the reference controls.

10. The system of claim 1, wherein the processing system is further configured to:
identify an additional control that is configured to enable the cloud service to further comply with the second compliance standard; and
cause a recommendation to be provided via a user interface, the recommendation recommending addition of the additional control to the custom control framework.

11. A method implemented by a computing system, the method comprising:
identifying reference controls of a reference control framework that define respective reference actions that, when performed, cause a cloud service to comply with a first compliance standard, each reference control having a respective first subset of text-based features such that each text-based feature in the respective first subset includes information regarding the reference control;
receiving a question pertaining to compliance of the cloud service with a second compliance standard that is different from the first compliance standard, the question having a second subset of the text-based features such that each text-based feature in the second subset includes information regarding the question;
determining scores for the respective reference controls using a supervised natural language processing machine learning model such that the scores are based at least on respective probabilities that the respective first subsets of the text-based features of the respective reference controls correspond to the second subset of the text-based features of the question; and
generating a compliance map for the cloud service by automatically mapping the question to a subset of the reference controls using the supervised natural language processing machine learning model based at least on each reference control in the subset of the reference controls having a score that satisfies a score criterion.

12. The method of claim 11, further comprising:
converting the text-based features in the second subset into respective embeddings associated with the question using an input encoder; and
concatenating the embeddings associated with the question into an input vector;
wherein determining the scores for the respective reference controls comprises:
determining the scores for the respective reference controls using the input vector associated with the question as an input to a multi-label classifier that is included in the supervised natural language processing machine learning model.

13. The method of claim 11, further comprising:
concatenating the text-based features of the second subset to provide a text-based vector for the question; and
converting the text-based vector into an input vector associated with the question by using an input encoder to embed the text-based features that are concatenated in the text-based vector;
wherein determining the scores for the respective reference controls comprises:
determining the scores for the respective reference controls using the input vector associated with the question as an input to the supervised natural language processing machine learning model.

14. The method of claim 11, further comprising:
receiving a user-specified rule, which indicates a maximum number of reference controls to be included in the subset of the reference controls to which the question is to be mapped; and
based at least on receipt of the user-specified rule, defining the subset of the reference controls to which the question is to be mapped to include no more than the maximum number of reference controls.

15. The method of claim 11, further comprising:
determining confidences in the respective probabilities on which the plurality of respective scores are based;
wherein generating the compliance map comprises:
automatically mapping the question to the subset of the reference controls using the supervised natural language processing machine learning model further based at least on the confidence in the probability associated with each reference control in the subset of the reference controls being greater than or equal to a confidence threshold.

16. The method of claim 11, further comprising:
causing an identifier that is associated with each reference control in the subset of the reference controls that is mapped to the question and the score for the respective reference control to be presented via a first user interface;
identifying a user-selected control that is selected via a second user interface from the subset of the reference controls that is mapped to the question; and
training the supervised natural language processing machine learning model by providing sample input-output pairs to the supervised natural language processing machine learning model, each sample input-output pair including a respective input that represents a respective question pertaining to compliance of the cloud service with a compliance standard and a respective output that represents the user-selected control that is selected via the second user interface from the subset of the reference controls that is mapped to the question.

17. The method of claim 11, further comprising:
training the NLP ML model using labels, each label indicating a mapping of a question to a reference control, each question pertaining to compliance of the cloud service with a compliance standard;
wherein training the NLP ML model comprises:
causing the NLP ML model to take into consideration dependencies between the labels by optimizing weights associated with the respective reference controls simultaneously.

18. The method of claim 11, wherein the first subset of text-based features of each reference control indicates at least one of the following:
a control type in which the reference control is categorized;
a title of the reference control;
a description of functionality of the reference control;
a manner in which the reference control is implemented.

19. The method of claim 11, further comprising:
causing a user interface to be presented, the user interface specifying each reference control in the subset of the reference controls that is mapped to the question, the user interface comprising:
a first interface element that enables a user to include a reference control in the subset of the reference controls in training data that is used to train the supervised natural language processing machine learning model;
a second interface element that enables the user to exclude a reference control in the subset of the reference controls from the training data;
a third interface element that enables the user to add a reference control to the subset of the reference controls.

20. A computer program product comprising a computer-readable storage medium having instructions recorded thereon for enabling a processor-based system to perform operations, the operations comprising:
identifying reference controls of a reference control framework that define respective reference actions that, when performed, cause a cloud service to comply with a first compliance standard, each reference control having a respective first subset of text-based features such that each text-based feature in the respective first subset includes information regarding the reference control;
identifying custom controls of a custom control framework that define respective custom actions that, when performed, cause the cloud service to comply with a second compliance standard that is different from the first compliance standard, each custom control having a respective second subset of the text-based features such that each text-based feature in the respective second subset includes information regarding the custom control;
for each custom control, determining a plurality of scores for the respective reference controls using a supervised natural language processing machine learning model such that the plurality of scores are based at least on respective probabilities that the respective first subsets of the text-based features of the respective reference controls correspond to the second subset of the text-based features of the custom control; and
generating a compliance map for the cloud service by automatically mapping each custom control of the custom control framework to a respective subset of the reference controls using the supervised natural language processing machine learning model based at least on each reference control in the respective subset of the reference controls having a score in the respective plurality of scores that satisfies a score criterion.
